(19) United States
(12) Patent Application Publication
(10) Pub. No.: US 2013/0062288 A1
(43) Pub. Date: Mar. 14, 2013

(54) PROGRAMMABLE FLUID TREATMENT SYSTEM AND METHOD

(71) Applicant: Wayne W. Spani, Mission Viejo, CA (US)

(72) Inventor: Wayne W. Spani, Mission Viejo, CA (US)

(21) Appl. No.: 13/610,800

(22) Filed: Sep. 11, 2012

Related U.S. Application Data
(60) Provisional application No. 61/573,666, filed on Sep. 12, 2011.

(51) Int. Cl. B01D 21/30; E02B 15/00; C02F 1/66; C02F 1/00

(52) U.S. Cl. 210/709; 210/96.1

(57) ABSTRACT

A programmable fluid treatment system including a mechanical subsystem and a computer control subsystem where the mechanical subsystem includes a fluid collection sump for capturing a fluid medium, a chemical mixing tank for injecting engineered chemicals into the fluid medium for separating a plurality of targeted compounds, an air flotation tank for creating a floating agglomeration of targeted compounds and engineered chemicals for mechanical removal, the computer control subsystem including a control unit for continuously monitoring a plurality of sensed parameters, a computer for continuously to comparing the sensed parameters with pre-programmed input data for continuously generating correction signals fed back to the mechanical subsystem via the control unit for maintaining the sensed parameters within limitations set by regulation, and for continuously adjusting and realtime reporting to regulators, the operation of the mechanical subsystem including the engineered chemicals in accordance with a dynamic concentration of the is targeted compounds.

This patent application claims the priority date of and incorporates by reference the previously filed provisional patent application under 35 U.S.C. Section 111(b) entitled The Storm Water Treatment System, (STS) filed on Sep. 12, 2011 by Wayne William Spani and assigned the Application No. 61/573,666. This patent application further incorporates by reference via patent license agreement, U.S. Pat. No. 5,812,394 issued to Lewis et al. on Sep. 22, 1998.

### BACKGROUND OF THE INVENTION

1. Technical Field

The present invention relates to water quality systems. More specifically, the present invention relates to methods and apparatus for a programmable storm water treatment system utilized to extract and remove compounds, metals and other materials from storm water accumulated on commercial and industrial premises prior to off-site discharge, and more particularly to an active storm water treatment system controlled by a programmable computer control system that receives input status signals from and transmits revised and updated control signals to a storm water treatment system via a control feedback loop for continuously controlling and verifying the operation of the storm water treatment system.

2. Background Art

In general, water falling on the facilities of commercial and industrial businesses is required to be collected on the business premises and stored in a business sump collection system prior to being discharged from the business premises to the public storm water drain system. Each business sump collection system is licensed by the regional water quality control board and periodically inspected. The processed water discharged from the business sump collection system must meet certain water quality standards before the water collected in the business sump collection system may be discharged to the city storm water drain system. The water quality standards are defined by the license permit issued to the business.

Prior commercial and industrial property owners used media filter systems comprised of sand or anthracite, carbon, pulverized walnut shells or the like to trap or absorb chemicals and pollutants as required by their license permits. Media filters are manufactured by specific companies and are installed by environment companies. Unfortunately, current media filters in use are not efficient and become clogged with chemicals and debris and thus require pressure to drive the storm water through the media filter. Since the storm water is typically gravity drained off of the commercial and industrial premises, there is no differential pressure to drive the storm water through a clogged media filter. To be effective, pumps are required to drive the storm water through the media filter.

The media filtration system is known in the industry as a “passive filtration system”. In order to keep this system functioning properly, the passive media filter must be changed out regularly. This is typically accomplished by shoveling, for example, the sand out of the pressure container of the media filter and then replacing fresh media back into the pressure container of the media filter. The commercial or industrial businesses are saddled with the financial burden to maintain their sump collection system. Unfortunately, the passive filtration system is not efficient and water samples fail the discharge tests notwithstanding the presence or absence of a properly working media filter. Inspectors from the Regional Water Quality Control Board are assigned to inspect and test the storm water flowing downstream of the media filters by opening an underground vault and extracting a water sample. Much fraud exists in that {a} media filters are removed by owner personnel to avoid the clogging problem, {b} the Water Quality Control Board is under-staffed, or {c} the inspection personnel fail to collect the downstream water samples since it is an undesirable task.

Prior art patents will now be mentioned that appear to be somewhat relevant to the programmable fluid treatment system of the present invention.

In U.S. Patent Publication No. US 2011/0210049 (O'Regan, Jr.), a modularizable system for water treatment having a low energy requirement to process water for reuse at a residence is disclosed. A settlement tank 410 and an aeration tank 426 where the water is stirred with a paddle and a mixer is disclosed. A communicator such as a programmable integrated circuit 362 communicates information about water quality to a central station. The term flocculant is recited in the disclosure. The sensed parameters pH, temperature, turbidity, hardness and metal are recited.

In U.S. Patent Publication No. US 2006/0289358 (Milchuck), a method for removing contaminant particles from storm water is disclosed. A collection tank or basin 32 is utilized to collect dirty water 20. A flocculant supply system 100 includes a controller 142, an electronic controller such as a programmable logic controller (PLC) to control the operation of a mixer 130 and/or the operation of a supply pump 150. FIG. 3 of Milchuck also illustrates a holding tank 120 in addition to the supply pump 150 and the mixer 130. Milchuck further recites a transfer pump 40.

In U.S. Patent Publication No. US 2011/0266215 (Robinson et al.), an advanced water treatment method processes a continuous flow of water in a sequence of stages utilizing a recycled dense micro-algae culture. Pumps 206 and 208 are disclosed. A sensory control and data acquisition (SCADA) system is introduced for electronically managing the treatment process environment for productive algae growth. The term flocculant is utilized and the parameters of temperature, pH, alkalinity, and pressure of the flow are recited.

In U.S. Patent Publication No. US 2012/0000859 (Mitzlaff et al.), a system and method for treating a wastewater stream to produce an effluent having an acceptable level of turbidity is disclosed. A system 10 includes a flow meter 140 disposed in the wastewater inlet line 40 capable of measuring the flow rate of the wastewater through inlet 40. A pH meter 150 is also disclosed. A controller 100 in the system 10 is disclosed as having a microprocessor 102, and a data memory 104 for storing process variables. An operator interface 120 may be operatively coupled to controller 100 to enable a user to monitor and control the system operation utilizing video displays, touch screens, and keyboards. Chemical additives are mentioned and flocculant tubes 60 are recited. A tank 30 is identified as a diffused air flotation (DAF) tank for introducing air bubbles into the waste water 1 for aiding in separation and flotation of coagulated solids to the surface of tank 30. A pH pump 220 is recited and shown in FIG. 2, and pumps 200, 210 and 220 are also mentioned.

In U.S. Pat. No. 3,775,311 to Mook, a screening aerator concentrator for separating waste water into a waste containing concentrate and a relatively waste free effluent is disclosed. Flocculants and pH regulators and frothers are recited. Further, Mook recites air stream, frothing, foaming, bubbles trap particles and oil. Small particle removal is also discussed.

In U.S. Patent Publication No. US 2010/0163492 (Andrilenas et al.) is directed to a method for processing contaminated water. A separation unit 1700 is shown in FIG. 17 for removing suspended solids from collected rain water. The terms pH adjustment unit, chemical addition units, and surfactant or flocculants addition units are mentioned. A multi-directional valve is disclosed.

In U.S. Pat. No. 3,637,490 to Gardner et al., a method for the removal of waste solids from industrial and municipal waste water in a flotation apparatus 8 is disclosed utilizing microballoon agents and flocculant polymers. Flotation agents plus the flocculant cause the waste solids to separate from the waste water and to float. The floating waste solids are removed from the flotation apparatus 8 as surface scum 12. FIGS. 1 and 2 both illustrate air bubbles within the rectangular vessel 9 of the flotation apparatus 8.

Thus, there is a need in the art for a programmable fluid treatment system utilized to extract and remove compounds, metals and other materials from waste fluid media that accumulates on commercial and industrial premises prior to off-site discharge which (1) does not utilize conventional media filtration arrangements, (2) cannot be physically fouled or clogged, (3) requires extremely low maintenance and upkeep, (4) is free from back flush problems, and (5) comprises an active programmable fluid treatment system including {a} a mechanical subsystem for separating and removing targeted compounds from waste fluid media, and {b} a programmable computer control subsystem arranged for continuous real time monitoring of a plurality of sensed parameters from the mechanical subsystem, and for continuously comparing the sensed parameters with a plurality of preprogrammed input data for continuously generating a plurality of correction signals fed back to the mechanical subsystem for maintaining the sensed parameters of the fluid medium within limitations set by and reported to a regulatory authority in real time in accordance with a dynamically changing concentration of the targeted compounds.

### DISCLOSURE OF THE INVENTION

Briefly, and in general terms, the present invention provides a new and improved programmable fluid treatment system for use in extracting and removing targeted compounds, metals and other materials from fluid media runoff accumulated on commercial and industrial premises prior to off-site discharge to municipal storm water drain systems in accordance with the specifications of the Regional Water Quality Control Board. Further, the present invention is an active fluid treatment system that includes a mechanical subsystem and a programmable computer control subsystem (PCCS) where the mechanical subsystem is constantly monitored and controlled by the programmable computer control subsystem (PCCS). The programmable computer control subsystem (PCCS) receives a continuous stream of sensed parameter input signals or input data from the mechanical subsystem and then transmits revised and updated correction signals back to the mechanical subsystem via a control feedback loop. This design enables continuous adjusting and reporting in real time to the Regional Water Quality Control Board of the condition of the captured fluid medium and the operation of the programmable fluid treatment system.

In the programmable fluid treatment system and method, the programmable computer control subsystem (PCCS) controls and continuously monitors the main parameters and operation of the mechanical subsystem. The function of the mechanical subsystem is to capture a fluid medium (such as on-site storm water), separate a plurality of targeted compounds from the fluid medium, mechanically dispose of the targeted compounds, and discharge the processed fluid medium to the local municipal storm water drain system in accordance with the rules of the Regional Water Quality Control Board. Each of the components of the mechanical subsystem communicates electronically with the programmable computer control subsystem (PCCS) for enabling continuous monitoring and operational control of the mechanical subsystem by the programmable computer control subsystem (PCCS). This unique design enables convenient, remote on-line monitoring and fluid sample evaluation by the Regional Water Quality Control Board of the fluid medium at, for example, the discharge stage of the programmable fluid treatment system.

The mechanical subsystem includes a fluid collection sump which receives the captured fluid medium (such as storm water) that falls onto commercial and industrial premises during rain storms and is collected and routed to the collection sump. The collection sump further includes a mixer motor utilized for turning a plurality of propellers to maintain the targeted compounds in solution. The fluid medium including the solution of targeted compounds is pumped through the mechanical subsystem to a first flow sensor and to a first bank of parameter sensors. The flow signal and rate of flow of the fluid medium and the sensed parameters including temperature, pH, resistivity and conductivity/total dissolved solids are reported to the programmable computer control subsystem (PCCS). The sensed parameters are measured at several locations throughout the programmable fluid treatment system.

The fluid medium is then directed to a chemical mix surge tank which functions to inject a mix of engineered chemicals into the fluid medium from the collection sump for separating out the targeted compounds and for controlling the pH level of the fluid medium. This section of the mechanical subsystem further includes (1) a chemical metering pump, and (2) a pH chemical metering pump for measuring and injecting the engineered chemicals into the fluid medium within the chemical mixing surge tank under the control of the programmable computer control subsystem (PCCS), and (3) a flocculant media mixer with dual propellers to ensure that the engineered chemicals injected into the chemical mix surge tank are thoroughly mixed with the targeted compounds present in the fluid medium.

The fluid medium along with the targeted compounds and engineered chemicals are pumped through a second flow valve and a second bank of parameter sensors to a diffused air flotation (DAF) tank. The rate of flow of the fluid medium and sensed operating parameters including temperature, pH, resistivity and conductivity/total dissolved solids are again reported to the programmable computer control subsystem (PCCS). Additionally, (1) a diffused air pump is associated with the diffused air flotation (DAF) tank for forcibly distributing air throughout the fluid medium, and (2) a fine air bubblier is included for creating fine bubbles for mixing with the fluid medium, targeted compounds, and engineered chemicals. The combination of the fluid medium, targeted compounds and engineered chemicals create a floating agglomeration in the diffused air flotation (DAF) tank. The fine bubbles and forced air within the fluid medium assist in the formation and rise of the floating agglomeration in the fluid medium. The floating agglomeration rises to the top of the fluid medium and is mechanically removed typically by being routed into a discharge pipe leading to a temporary storage container.

The processed fluid medium is then passed through a specific gravity separator (SGS) tank which is a multi-chamber settling tank having a tortuous path and a coalescing material for filtering out fine particles remaining in the fluid medium. The coalescing material can be comprised of any suitable material such as polypropylene. The processed fluid medium is then passed to a discharge surge tank, and then pumped through a final flow sensor, a third bank of parameter sensors, a final stage cartridge filter, and a fourth and final bank of parameter sensors. If the programmable computer control subsystem (PCCS) determines that the condition of the processed fluid medium satisfies the requirements of the Regional Water Quality Control Board, then the processed fluid medium is discharged to the local municipal storm water drain system. If the condition of the processed fluid medium fails to satisfy the regulations, then the processed fluid medium is re-circulated through the programmable fluid treatment system.

The programmable computer control subsystem (PCCS) is employed for controlling and continuously monitoring each stage of the mechanical subsystem for ensuring proper operation thereof. Each major component of the mechanical subsystem is in electronic communication with the programmable computer control subsystem (PCCS). In this manner, the condition of the processed fluid medium will satisfy the regulations of the Regional Water Quality Control Board and the processed fluid medium will be discharged to the local municipal storm water drain system. The programmable computer control subsystem (PCCS) is housed within a National Electrical Manufacturers Association (NEMA) rated control panel enclosure which contains the main components including a plurality of digital/analog, input/output modules commonly referred to as an input/output board rack. Each of the sensor devices such as the flow sensors and the multiple banks of parameter sensors located in the mechanical subsystem periodically sense, for example, the flow rate, temperature, pH, resistivity, conductivity/total dissolved solids and other parameters of the fluid medium. These sensed parameters are transmitted to and are identified by the input/output board rack located in the programmable computer control subsystem (PCCS) and are then forwarded to a field control unit (FCU) which is a local microprocessor unit.

The field control unit (FCU) continuously monitors the plurality of sensed parameters and is utilized for control logic execution and direct scanning of the sensed parameters (e.g., input/output data of the mechanical subsystem) from the input/output board rack into a computer located at an operator workstation. The operator workstation is utilized as an operator interface with the programmable computer control subsystem (PCCS). Among other functions, the computer continuously interprets and compares the sensed parameters with a plurality of pre-programmed input data stored within the computer for generating a plurality of correction signals. These correction signals are transmitted back to the field control unit (FCU) via a feedback loop and subsequently transmitted to the proper locations in the input/output board rack and the mechanical subsystem. These correction signals facilitate adjustments and control modifications to the mechanical subsystem for maintaining the sensed parameters of the fluid medium within the specified limitations set by the Regional Water Quality Control Board. Because of the continuous monitoring of the sensed parameters by the field control unit (FCU) and the continuous interpreting and comparing of the sensed parameters with the pre-programmed input data, the required adjustments and control modifications to the mechanical subsystem can be verified as having actually been made.

As a result, the present invention facilitates the continuous adjusting and correcting of the sensed parameters and reporting on-line and in real time to the regulatory authority. This continuous reporting includes the current operation of the mechanical subsystem including the mix of the engineered chemicals and the condition of the fluid medium. This important feature is extremely significant in that the concentration of the targeted compounds during a rain event can be dynamic, that is, constantly changing. Thus the operation of the programmable fluid treatment system can be modified to address this dynamic situation. Under these conditions, the sensed parameters of temperature, pH, resistivity, conductivity/total dissolved solids can be constantly monitored as well as flocculant chemical metering levels, pump speeds, fluid medium flow rates and the like. Thus, the rigid standards set by the Regional Water Quality Control Board can be satisfied prior to the discharge of the processed fluid medium into the local municipal storm water drain system.

Further features of the programmable computer control subsystem include an engineering work station (EWS). The engineering work station (EWS) is utilized by technical personnel to program logic code into and download that programmed logic code from a separate computer at an engineering work station (EWS) onto the computer located at the operator's work station (OWS) for changing parameters when changing out field components or hardware. Only the programmer/engineer at the engineering work station (EWS) has access to the computer located at the engineering work station (EWS) which may be a desktop or laptop type. The computer located at the engineering work station (EWS) is typically a remote station and is used solely to write the programming logic and select the system configuration for the programmable fluid treatment system. Access from off-site locations (which can be any location external to the programmable fluid treatment system) is available to communicate with the computer at the operator's work station (OWS) for obtaining the most current sensed parameter readings available. Off-site locations, including the engineering work station (EWS), can communicate with the programmable fluid treatment system by any of several methods including, for example, radio frequency, modem, satellite, telephone lines, ethernet or internet, or the like. The programmable fluid treatment system includes an antenna to facilitate this communication.

The present invention is generally directed to a programmable fluid treatment system including a mechanical subsystem and a programmable computer control subsystem (PCCS) wherein the mechanical subsystem includes a fluid collection sump for capturing, storing, and distributing a fluid medium, a chemical mixing surge tank for injecting a mix of engineered chemicals into the fluid medium for separating out a plurality of targeted compounds and for controlling the pH level of the fluid medium, a diffused air flotation (DAF) tank for creating a floating agglomeration of targeted compounds and engineered chemicals for mechanical removal, the programmable computer control subsystem (PCCS) including a control unit arranged for continuously monitoring a plurality of sensed parameters from the mechanical subsystem, a computer for continuously comparing the sensed parameters with preprogrammed input data for continuously generating correction signals fed back to the mechanical subsystem via the control unit for maintaining the sensed parameters of the fluid medium within limitations set by a regulatory authority, and for continuously adjusting and reporting in real time to the regulatory authority, the operation of the mechanical subsystem including the engineered chemicals in accordance with a dynamically changing concentration of the targeted compounds.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1 is a block diagram of a programmable fluid treatment system of the present invention showing a mechanical subsystem and a programmable computer control subsystem (PCCS) including an antenna for enabling communication therewith.

FIG. 2 is another block diagram of the programmable fluid treatment system of FIG. 1 showing the mechanical subsystem and a more detailed view of the programmable computer control subsystem (PCCS) including a touch screen control.

FIG. 3A-3B is a schematic diagram of the programmable fluid treatment system of FIG. 1 showing a detailed view of the mechanical subsystem including fluid collection, chemical injection, and the separation of fluid and targeted compounds, and a block representing the programmable computer control subsystem (PCCS) shown in FIG. 2.

FIG. 4 is a perspective view of a field control unit (FCU) combined with digital/analog-input/output modules which serve to enable communication between the mechanical subsystem and a computer in the programmable computer control subsystem (PCCS) of FIG. 2 for receiving and evaluating measured parameters from and returning correction signals to the mechanical subsystem.

FIG. 5 is an illustration of a communications link showing possible communication paths between the programmable computer control subsystem (PCCS) of the programmable fluid treatment system of FIG. 2 and various known communication apparatuses.

FIG. 6A-6C is a detailed flow diagram representing the operation of the programmable fluid treatment system of FIG. 1 beginning with a rain event and ending with the discharge of processed fluid to a municipal drainage system.

### DETAILED DESCRIPTION OF THE INVENTION

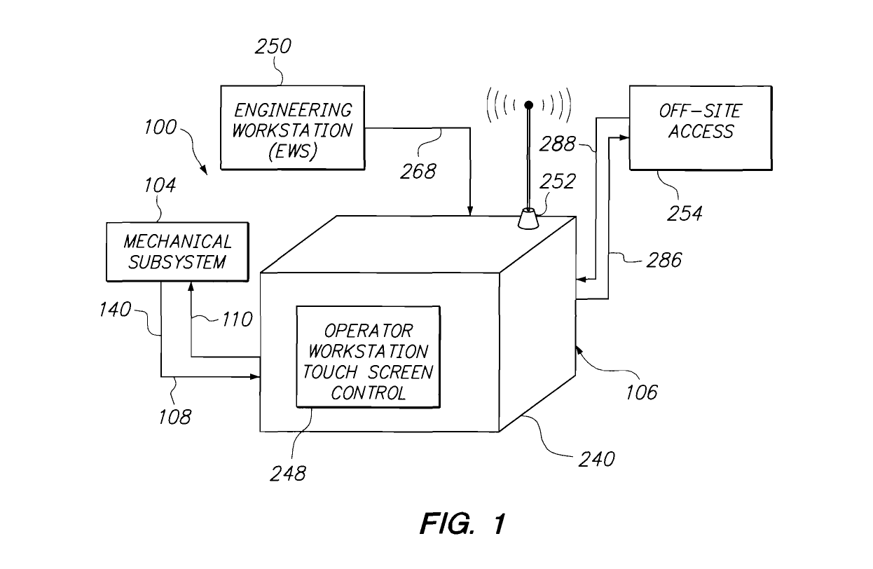

The present invention relates to a programmable fluid treatment system and method 100 as shown in FIGS. 1-6C. In particular, the programmable fluid treatment system 100 is utilized for extracting and removing targeted compounds, metals and other materials from the runoff of a fluid medium 102 that accumulates on commercial and industrial properties such as, for example, during rain storms, prior to off-site discharge to municipal storm water drain systems (not shown). This process is typically conducted under the regulations of a Regional Water Quality Control Board to ensure that the fluid medium 102 meets the required conditions prior to discharge.

Further, the programmable fluid treatment system 100 is an active fluid treatment system that includes a mechanical subsystem 104 and a programmable computer control subsystem (PCCS) 106 where the mechanical subsystem 104 is constantly monitored and controlled by the programmable computer control subsystem (PCCS) 106. The programmable computer control subsystem (PCCS) 106 receives a continuous stream of sensed parameters 108 as input signals or input data from the mechanical subsystem 104 and then transmits revised and updated correction signals 110 back to the mechanical subsystem 104 via a control feedback loop. This design enables the continuous adjusting and reporting in real time to the Regional Water Quality Control Board of the condition of the captured fluid medium 102 and the operation of the programmable fluid treatment system 100.

In the programmable fluid treatment system 100, the programmable computer control subsystem (PCCS) 106 controls and continuously monitors the plurality of sensed parameters 108 and operation of the mechanical subsystem 104. The function of the mechanical subsystem 104 is to capture the fluid medium 102 (such as on-site storm water), separate a plurality of targeted compounds from the fluid medium 102, mechanically dispose of the targeted compounds, and discharge the processed fluid medium 102 to the local municipal storm water drain system in accordance with the regulations of the Regional Water Quality Control Board. Each of the components of the mechanical subsystem 104 communicates electronically with the programmable computer control subsystem (PCCS) 106 for enabling continuous monitoring and operational control of the mechanical subsystem 104 by the programmable computer control subsystem (PCCS) 106. This unique design enables convenient, remote on-line monitoring and fluid sample evaluation by the Regional Water Quality Control Board of the fluid medium 102 at, for example, the discharge stage of the programmable fluid treatment system 100.

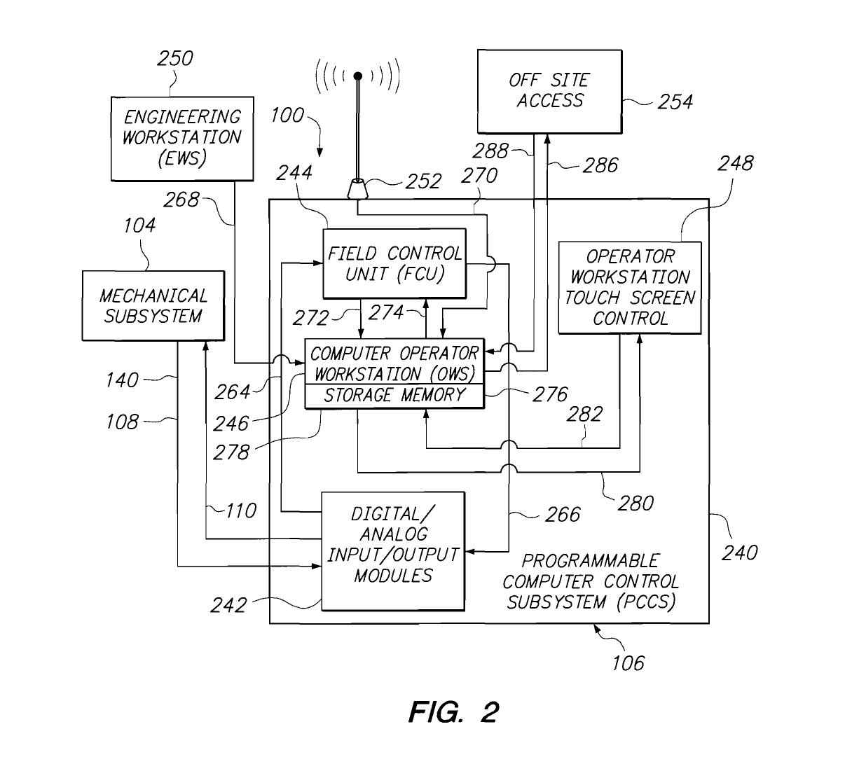

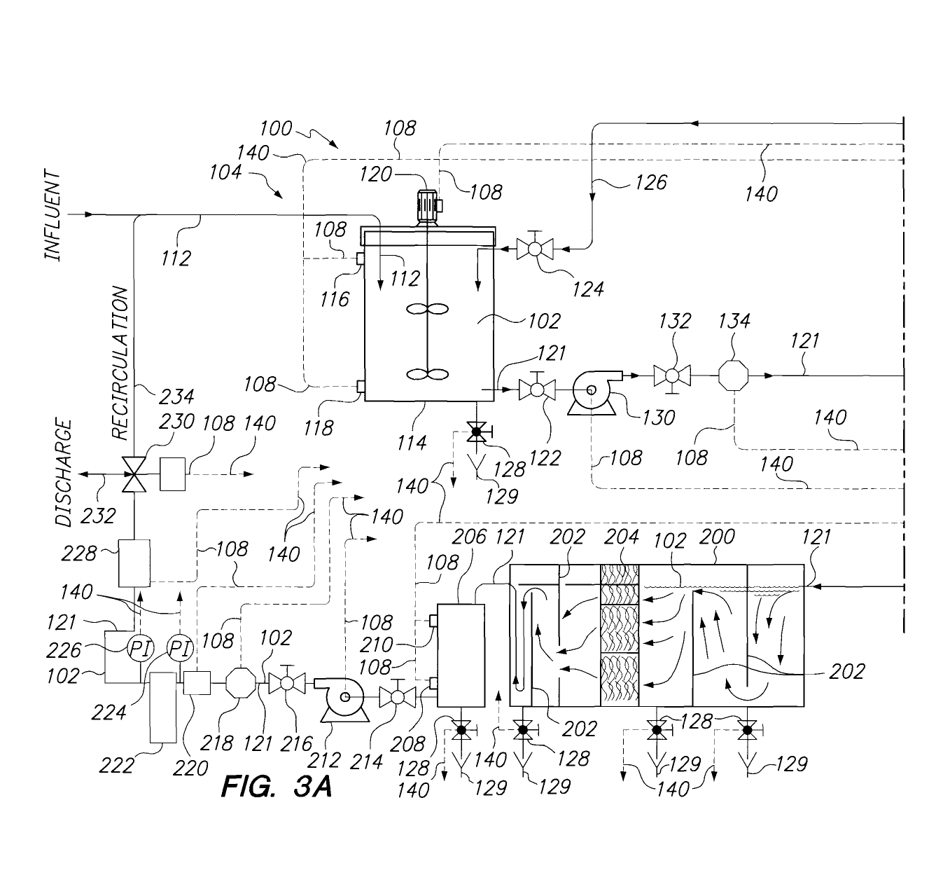

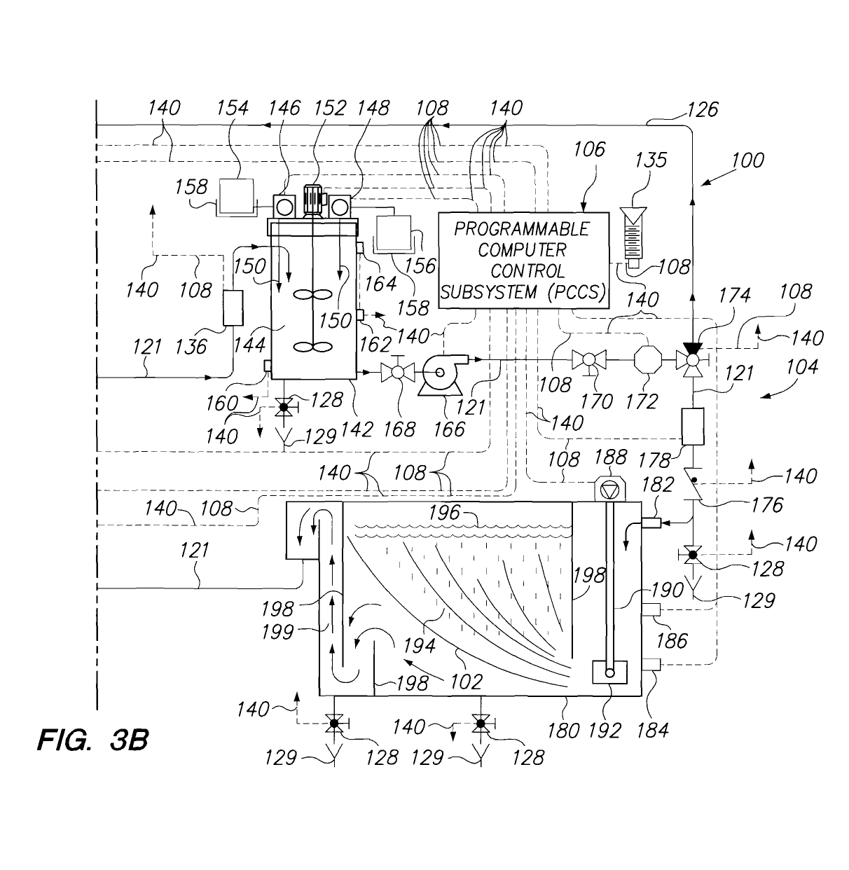

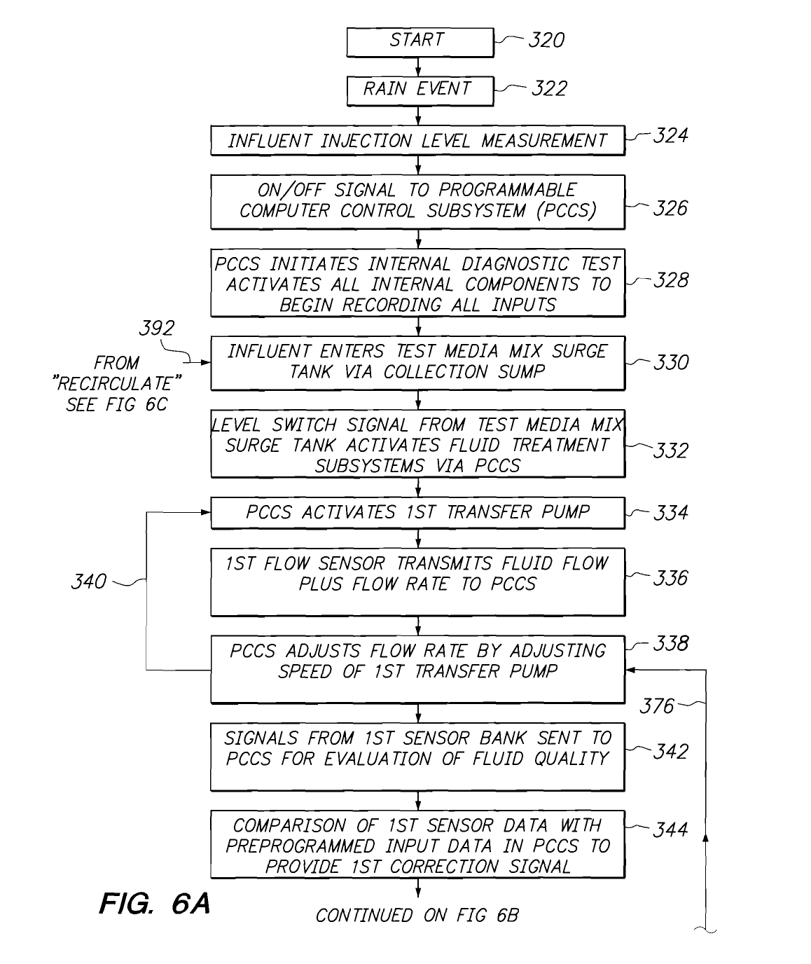

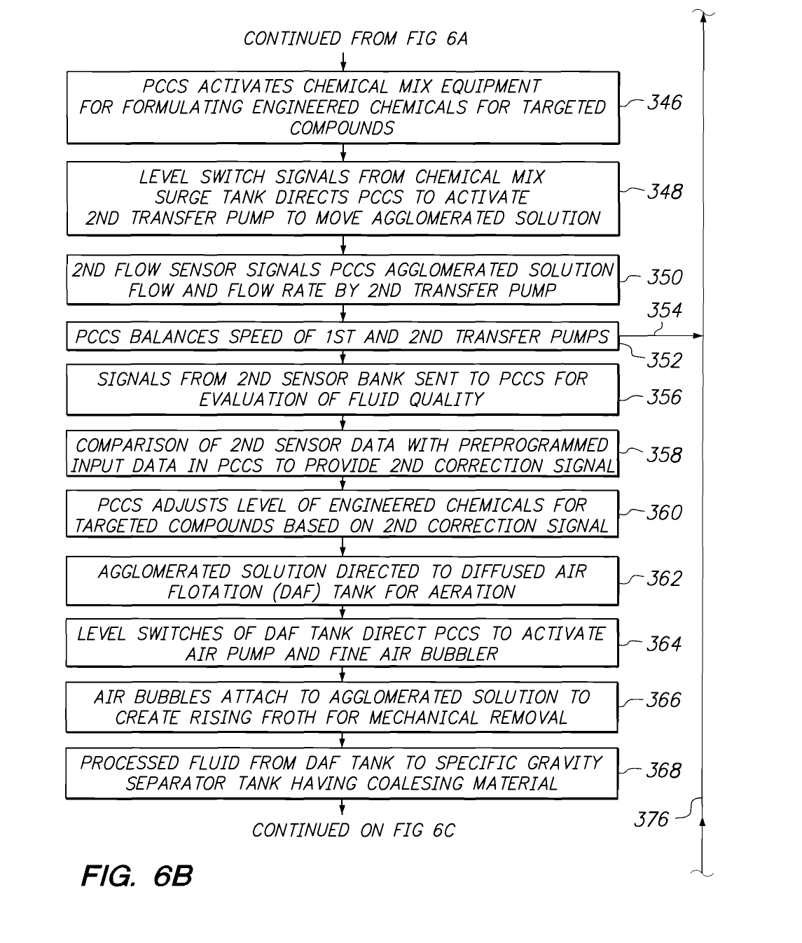

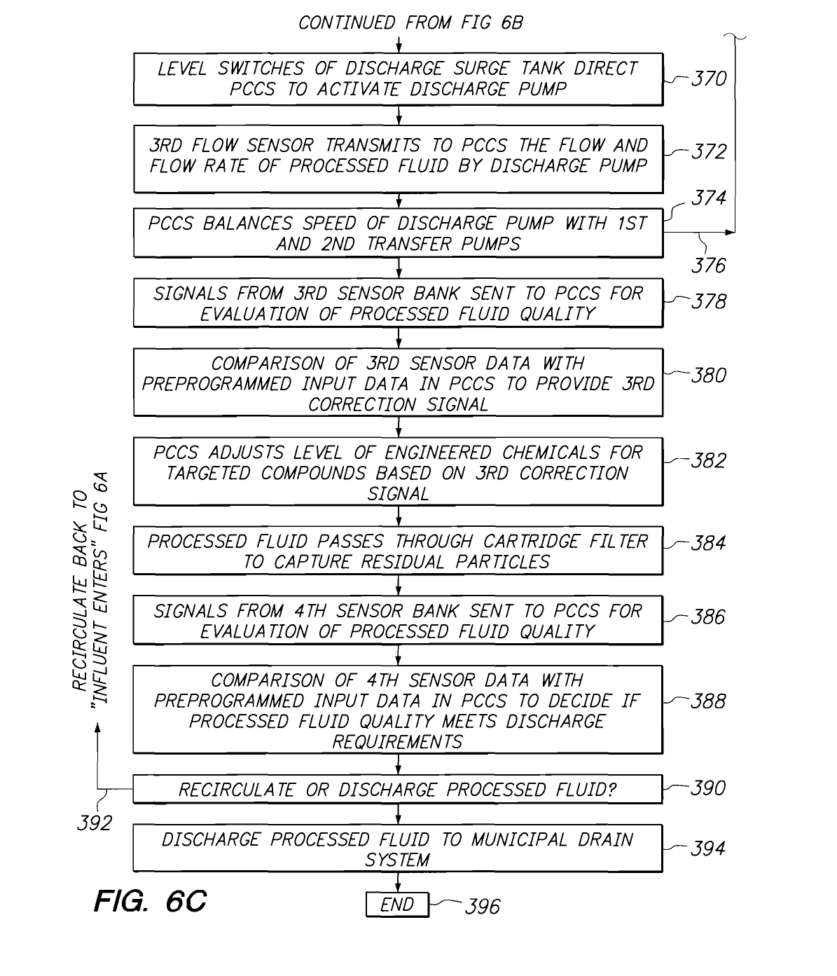

A detailed discussion of the mechanical subsystem 104 will now be introduced prior to discussing the programmable computer control subsystem (PCCS) 106 and the operation of the programmable fluid treatment system 100 as disclosed in the flow diagram shown in FIGS. 6A-6C. The mechanical subsystem 104 is shown separate from but electrically connected to the programmable computer control subsystem (PCCS) 106 in FIGS. 1 and 2. A detailed view of the mechanical subsystem 104 is shown in FIGS. 3A-3B and reference to these drawings should be made during this portion of the discussion. In the preferred embodiment of the present invention, it is presumed that the fluid medium 102 shown as the “influent” on the upper left corner of FIG. 3A is storm water containing various foreign matter such as, for example, chemical compounds, metals and other foreign materials. However, it is understood that the present invention will find utility in processing fluid mediums 102 other than storm water. It is required by the Regional Water Quality Control Boards that this foreign matter be removed from the fluid medium 102 prior to discharge into the municipal storm water drain systems. Consequently, local, state and federal regulations now exist specifically defining the required condition and quality that the fluid medium 102 must meet prior to being discharged into storm water drain systems. In particular, the regulations specify what compounds and foreign matter must be extracted, e.g., may not be present in the fluid medium 102 that is discharged into the municipal storm water drain systems. The present invention addresses these requirements by providing a programmable fluid treatment system 100 that continuously monitors the relevant sensed parameters 108 of the programmable fluid treatment system 100 to ensure the extraction and removal of the compounds, metals and other materials from the processed fluid medium 102 prior to off-site discharge in accordance with these requirements.

The mechanical subsystem 104 includes a collection facility for the fluid medium 102 located on the premises of the relevant commercial or industrial business. In a suitable pre-production prototype, a subsurface test media mix tank can be utilized to test the mechanical subsystem 104. However, in a production system, the owner of the premises upon which the fluid medium 102 exists would install a fluid collector represented by identification number 112 on FIG. 3A comprising a plurality of drains and pipes for collecting the fluid medium 102. The fluid medium 102 would then flow from the fluid collector 112 into a fluid collection sump 114 as shown on FIG. 3A. The fluid collection sump 114 assures that there is sufficient fluid medium 102 to activate and operate the programmable fluid treatment system 100 via the use of level control switches 116 and 118. The high level switch 116 activates the fluid treatment system 100 by indicating that the fluid collection sump 114 is full. This action, in turn, energizes a media mixer motor 120 which is mounted on top of the fluid collection sump 114. The media mixer motor 120 can be a 1/4 HP, 115/230 volt motor with dual propellers intended for agitating the contents of the fluid medium 102 for preventing the separation of contaminants thereof (e.g., oils, heavy metals, silt, etc.) prior to chemical treatment in a later stage of the fluid treatment system 100. The low level switch 118 indicates that the level of the fluid medium 102 is too low and thus de-activates the fluid treatment system 100. The output of the fluid collection sump 114 is delivered to a fluid processing line 121 as shown in FIG. 3A.

A pair of 2″ polyvinylchloride (PVC) through port ball valves 122 and 124 are positioned in the fluid processing line 121 in FIG. 3A for isolating and removing the fluid collection sump 114 from service to permit periodic maintenance thereto. The ball valve 124 is also a component of the fluid media re-circulation line 126 employed for re-directing the fluid medium 102 back through the programmable fluid treatment system 100 if the measured parameters are unacceptable or if the mechanical subsystem 104 is being flushed. A polyvinylchloride (PVC), 1″ ball valve 128 is one of a plurality of identical drain valves utilized to enable each tank, in this case the fluid collection sump 114, to be drained into a drain path 129 and cleaned. A first transfer pump 130 shown in FIG. 3A can be a 150 gallon/minute (gpm)@25 psig max, 230 volt, 3-phase centrifugal pump, variable drive type. The variable drive feature of the transfer pump 130 enables the speed of the pump to be varied according to the pumping demand requirements. The transfer pump 130 functions to direct the fluid medium 102 further along the programmable fluid treatment system 100. A third 2″ PVC through port True Union ball valve 132 is positioned on the downstream side of the first transfer pump 130. Both the ball valve 122 and the ball valve 132 serve as isolation valves for isolating the transfer pump 130 for maintenance and repair.

Downstream of isolation ball valve 132 is a first flow sensor 134 which can be a Signet No. 3-2536-PO having a 2″ installation fitting. The first flow sensor 134 serves to (a) recognize that the fluid medium 102 is flowing in the programmable fluid treatment system 100, and (b) measure the flow rate or speed at which the fluid medium 102 is moving through the fluid treatment system 100. The first flow sensor 134 is shown connected to the programmable computer control subsystem (PCCS) 106 via a (4-20) milliamp communication line 140 specifically for transmitting the sensed parameters 108 to and receiving correction signals 110 from the programmable computer control subsystem (PCCS) 106 for control purposes. The flow rate of the fluid medium 102 represented by the sensed parameter 108 from the first flow sensor 134 is compared with the flow rate of the fluid medium 102 as assigned by the programmable computer control subsystem (PCCS) 106. If a differential between the two flow rates exists, then the correction signal 110 (as shown in FIGS. 1 and 2) adjusts the speed of the first transfer pump 130 shown in FIG. 3A so that the fluid medium 102 moves through the entire mechanical subsystem 104 at a uniform rate. Since the programmable computer control subsystem (PCCS) 106 relies on the sensed parameters 108 from the first flow sensor 134, then the flow rate measured by the first flow sensor 134 effectively controls the speed of the first transfer pump 130.

A rainfall totalizer 135 is incorporated into the present invention as shown on FIG. 3B and is utilized to collect rainfall and precipitation falling in the area of the business premises. It is noted that the rainfall totalizer 135 is shown connected to the programmable computer control subsystem (PCCS) 106 via a (4-20) milliamp communication line 140 specifically for transmitting the sensed parameters 108 to and receiving correction signals 110 from the programmable computer control subsystem (PCCS) 106 for control purposes. Thus, the rainfall totalizer 135 transmits data to the programmable computer control subsystem (PCCS) 106 in the form of the sensed parameters 108 in the case of moisture accumulation. As a result, the programmable computer control subsystem (PCCS) 106 receives signals from each of the flow sensors and particularly the first flow sensor 134, the rainfall totalizer 135, and a plurality of pre-programmed input data stored within the programmable computer control subsystem (PCCS) 106. This combination of sensed parameters 108, indicates to the programmable computer control subsystem (PCCS) 106 how much fluid medium 102 to expect and at what flow rate the programmable computer control subsystem (PCCS) 106 should anticipate operating at.

After passing the first flow sensor 134, the fluid medium 102 encounters the first bank of parameter sensors 136 located in the fluid processing line 121 shown in FIG. 3B and utilized for measuring the sensed parameters 108 of the fluid medium 102 including temperature, pH, resistivity and the conductivity/total dissolved solids (TDS). This first bank of parameter sensors 136 serves to continuously track the plurality of sensed parameters 108 just enumerated. The temperature sensor can be Signet Model No. 3-2350-1, the pH sensor can be a Myron Model No. EQP-MLP74F, the resistivity sensor can be a Myron Model No. C510 (EQP-MLCS10), and the conductivity/TDS sensor can be a Myron Model No. C550 (EQP-MLC50). Each of these four sensors is represented as being located in the same enclosure which comprises the first bank of parameter sensors 136. Further, there are four identical banks of these parameter sensors distributed throughout the programmable fluid treatment system 100 for providing a constant stream of data on a real time basis to the programmable computer control subsystem (PCCS) 106. In this manner, the computer control subsystem (PCCS) 106 can continuously monitor the mechanical subsystem 104 and track the plurality of sensed parameters 108 during operation.

Further, each of the main components described to this point in this detailed description including the high level control switch 116 and the low level control switch 118 of the fluid collection sump 114, media mixer motor 120, first transfer pump 130, first flow sensor 134, and the first bank of parameter sensors 136 is connected to the programmable computer control subsystem (PCCS) 106 via a (4-20) milliamp communication line 140. The communication line 140 is shown either as a dotted line routed directly to the programmable computer control subsystem (PCCS) 106 on FIGS. 3A-3B, or indicated by a dotted line with an arrowhead carrying the sensed parameters 108 to the programmable computer control subsystem (PCCS) 106. With regard to the first bank of parameter sensors 136, the sensed parameters 108 of the fluid medium 102 including the temperature, pH, resistivity, and conductivity/TDS are continuously measured and transmitted via the (4-20) milliamp communication line 140 on a real time basis and is utilized to determine and control the mix of chemicals to be injected into the fluid medium 102 during the next stage of the programmable fluid treatment system 100. It is further noted that the plurality of sensed parameters 108 is intended to represent all parameters measured and sensed in the mechanical subsystem 104 in additional to temperature, pH, resistivity, and conductivity/TDS.

Other measured parameters that are sensed parameters 108 and which are delivered to the programmable computer control subsystem (PCCS) 106 on the (4-20) milliamp communication line 140 include fluid levels in the various tanks such as, for example, the fluid collection sump 114, speed of the media mixer motor 120, pump speed such as, for example, the first transfer pump 130, flow rate of the fluid medium 102 through the first flow sensor 134, and other components of the mechanical subsystem 104 described or to be described herein below. Additionally, most valves shown in the mechanical subsystem 104 on FIGS. 3A-3B are also connected to the programmable computer control subsystem (PCCS) 106 via the (4-20) milliamp communication line 140. This inclusion of valves may also comprise each of the drain valves 128 associated with each of the container vessels already disclosed herein (such as the fluid collection sump 114) or to be disclosed hereinafter in this detailed specification.

The fluid medium 102 is then directed from the first bank of parameter sensors 136 in the fluid processing line 121 to a chemical mix surge tank 142 under the force of the first transfer pump 130 as shown in FIG. 3B. The chemical mix surge tank 142 can have dimensions of, for example, 30″×60″ and be fashioned from a suitable material such as fiber reinforced plastic. The function of the chemical mix surge tank 142 is to receive the fluid medium 102 from the fluid collection sump 114 and to inject and mix into the fluid medium 102 to be treated, the required chemistry (a) to cause separation of the compounds of concern or plurality of targeted compounds 144 specified in the operational site permit issued by the local Regional Water Quality Control Board, and (b) to control the pH level reading of the fluid medium 102. Prior to the fluid medium 102 being pumped into the chemical mix surge tank 142, the temperature, pH, resistivity, and conductivity/TDS are determined by the first bank of parameter sensors 136. The fluid medium 102 is then monitored and controlled via the first flow sensor 134, and by the temperature, pH, and the conductivity/TDS as measured by a conductivity meter, each located within the first bank of parameter sensors 136 as shown in FIG. 3B. These sensed parameters 108 are transmitted to the programmable computer control subsystem (PCCS) 106 on a real time basis as the data is continuously measured and is utilized to determine and control the preparation of the chemicals to be injected into the fluid medium 102.

This chemical injection section of the mechanical subsystem 104 further includes (1) a chemical metering pump 146, and (2) a pH chemical metering pump 148 as shown in FIG. 3B. The chemical metering pump 146 can be a (1-30) GPD, 115 volt, Model No. LC545A-PTC1, Pulsatron Series C, while the pH chemical metering pump 148 can be a (1-30) GPD, 115 volt, Model No. LC545A-PTC1, Pulsatron Series C Acid. The function of the chemical metering pump 146 and the pH chemical metering pump 148 is to inject a plurality of engineered chemicals 150 into the chemical mix surge tank 142. The engineered chemicals 150 include a chemical flocculant injected by the chemical metering pump 146 to cause the separation of the targeted compounds 144 from the fluid medium 102 as specified in the operational site permit granted by the Regional Water Quality Control Board. Further, chemicals suitable for controlling the pH level of the fluid medium 102 as specified by the operational site permit are injected by the pH chemical metering pump 148. These injected engineered chemicals 150 are mixed by a flocculant media mixer 152 which can be a 1/4 HP, 115/230 volt motor have dual propellers shown mounted on top of the chemical mix surge tank 142 in FIG. 3B. The flocculant media mixer 152 ensures that the engineered chemicals 150 injected into the chemical mix surge tank 142 are thoroughly mixed with the targeted compounds 144 present in the fluid medium 102 resulting in the desired separation. Each of the chemical metering pump 146, pH chemical metering pump 148, and flocculant media mixer 152 transmit sensed parameters 108 on a (4-20) milliamp communication line 140 to the programmable computer control subsystem (PCCS) 106 as shown in FIG. 3B.

The flocculant of the engineered chemicals 150 will be engineered to met the requirements of the fluid medium 102 influent on a site specific need. In particular, the engineered chemicals 150 are typically mixed by an outside vendor to meet the conditions specified by the conditional site permit issued by the Regional Water Quality Control Board. By providing the information appearing on the operational site permit and with knowledge of the particular targeted compounds 144, the outside vendor can manufacture and/or engineer the correct combination of chemicals. The engineered chemicals 150 are held in storage in a chemical flocculant holding tank 154 until pumped out and injected into the chemical mix surge tank 142 by the chemical metering pump 146 as shown in FIG. 3B. Likewise, the chemicals required to control the pH level of the fluid medium 102 are stored in a pH adjustment holding tank 156 until pumped out and injected into the chemical mix surge tank 142 by the pH chemical metering pump 148. These pH adjustment chemicals can be either acidic or basic to adjust the pH level of the fluid medium 102 to within the range of (6-8) where the pH scale is from (0-14) with the scale reading of 7.0 being neutral. Typically, it is necessary to add adjustment chemicals that are acidic which indicates that the fluid medium 102 is somewhat basic. It is the objective to adjust the pH level of the fluid medium 102 to a neutral reading of approximately 7.0. Both the chemical flocculant holding tank 154 and the pH adjustment holding tank 156 are positioned on a secondary containment bin 158 as shown in FIG. 3B to prevent overflow or spillage.

The chemical mix surge tank 142 includes three level control switches for controlling the operation thereof. Those level control switches include a low level control switch 160, a mid-level control switch 162, and a high level control switch 164. The low level control switch 160 signals that the level of fluid medium 102 in the chemical mix surge tank 142 is very low and shuts off the flocculant media mixer 152 and any associated transfer pumps. The mid-level control switch 162 signals that the fluid medium 102 is higher and activates the flocculant media mixer 152 which functions to thoroughly mix the engineered chemicals 150 with the targeted compounds 144. The high level control switch 164 signals that the level of the fluid medium 102 in the chemical mix surge tank 142 is very high and consequently activates a second transfer pump 166 located in the fluid processing line 121. The second transfer pump 166 functions to direct and further mixes the fluid medium 102 as it flows downstream. The fluid medium 102 in combination with the mix of engineered chemicals 150 then passes through a 2″ PVC through port True Union ball valve 168 prior to passing through the second transfer pump 166 as shown in FIG. 3B. The ball valve 168 is one of a pair of identical valves intended to isolate the second transfer pump 166. The second isolation valve is also a 2″ PVC through port True Union ball valve 170 shown just downstream of the second transfer pump 166 on FIG. 3B. The second transfer pump 166 is shown connected to the programmable computer control subsystem (PCCS) 106 via a (4-20) milliamp communication line 140 for transmitting the sensed parameters 108 to and for receiving the correction signals 110 from the programmable computer control subsystem (PCCS) 106 for pump control purposes.

The second transfer pump 166 is a (1-150) gpm@25 psig max low shear pump having variable drive and operating at 230 volt, three-phase, 60 Hz. The low shear feature means that the second transfer pump 166 operates in a manner to prevent shearing of the flocculants or engineered chemicals 150 from the contaminants of concern or targeted compounds 144 by utilizing any one of the following three types of pumps. A first type of pump is a vane pump which utilizes a paddle (not shown) for moving the fluid medium 102 somewhat like a revolving door. This design is unlike a centrifugal pump which utilizes blades which cut and compress the fluid medium 102 which results in shearing of the fluid medium 102. In the instant situation, use of a centrifugal pump would be counter-productive. The second type of pump is a peristaltic pump which operates on the principle of constriction, such as, in constriction of a tubular hose via a roller where the roller forces the fluid medium 102 through the tube (not shown). The third type of pump is a diaphragm pump which includes a diaphragm positioned within a chamber. When the chamber fills with the fluid medium 102, the diaphragm when actuated squeezes the fluid medium 102 out of the chamber similar to the operation of the human heart.

The fluid medium 102 plus the targeted compounds 144 and the engineered chemicals 150 mixed therewith are then driven by the second transfer pump 166 through a second flow sensor 172 as shown in FIG. 3B. The second flow sensor 172 can be a Signet No. 3-2536-PO having a 2″ installation fitting. The second flow sensor 172 serves to (a) recognize that the fluid medium 102 is flowing downstream of the second transfer pump 166 and the chemical mix surge tank 142, and (b) measure the flow rate or speed at which the fluid medium 102 is moving through the fluid treatment system 100. The second flow sensor 172 is shown connected to the programmable computer control subsystem (PCCS) 106 via a (4-20) milliamp communication line 140 specifically for transmitting the sensed parameters 108 to and receiving correction signals 110 from the programmable computer control subsystem (PCCS) 106 for control purposes. The flow rate of the fluid medium 102 represented by the sensed parameters 108 from the second flow sensor 172 is compared with the flow rate of the fluid medium 102 as assigned by the programmable computer control subsystem (PCCS) 106. If a difference between the two flow rates exists, then the correction signal 110 (as shown in FIGS. 1 and 2) adjusts the speed of the second transfer pump 166 shown in FIG. 3B so that the fluid medium 102 moves through the entire mechanical subsystem 104 at a uniform rate. Since the programmable computer control subsystem (PCCS) 106 relies on the sensed parameters 108 from the second flow sensor 172, then the flow rate measured by the second flow sensor 172 effectively controls the speed of the second transfer pump 166.

The fluid medium 102, targeted compounds 144, and the engineered chemicals 150 are then pumped through a re-circulation valve 174 which can be a 2″ diameter, 3-way PVC True Union ball valve as shown in FIG. 3B. The re-circulation valve 174 (also known as the shutdown valve) is utilized for cleansing of the mechanical subsystem 104 which includes the fluid collection sump 114 and the plumbing associated therewith, and the chemical mix surge tank 142. As can be seen in FIG. 3B, the fluid medium 102 can be drained out of the mechanical subsystem 104 through a 2″ diameter, PVC True Union ball check valve 176 positioned in the fluid processing line 121, and the corresponding drain valve 128 and into the drain path 129. Further, both the fluid collection sump 114 and the chemical mix surge tank 142 can be drained through their respective drain valves 128 into the drain path 129. Under these conditions, each of the fluid collection sump 114 and the chemical mix surge tank 142 can be vacuumed out by a commercial service to remove residue build-up. Thereafter, fresh water can be directed through the fluid collection sump 114, the first transfer pump 130, the chemical mix surge tank 142, the second transfer pump 166, and the re-circulation valve 174.

The re-circulation valve 174 and the ball check valve 176 are shown connected to the programmable computer control subsystem (PCCS) 106 via a (4-20) milliamp communication line 140 to facilitate control thereof. The re-circulation valve 174 can be positioned to flush the fresh water through the ball check valve 176 and the corresponding drain valve 128 to the drain path 129. In the alternative, the re-circulation valve 174 can be controlled to direct the fresh water through the re-circulation line 126 and top isolation ball valve 124 shown feeding back into the fluid collection sump 114. The fresh water can then be cycled through the fluid collection sump 114, the chemical mix surge tank 142, and the re-circulation valve 174, and then flushed out of the corresponding drain valve 128 and drain path 129. Thereafter, the valve arrangement can be reset and the fluid collection sump 114 can be recharged with additional fluid medium 102 or influent during the next rain event to restart the fluid treatment process again.

After the fluid medium 102, targeted compounds 144 and engineered chemicals 150 pass through the re-circulation valve 174, they are directed through a second bank of parameter sensors 178 positioned in the fluid processing line 121 as shown on FIG. 3B. As with the first bank of parameter sensors 136, the second bank of parameter sensors 178 is utilized for measuring the sensed parameters 108 of the fluid medium 102 including temperature, pH, resistivity and the conductivity/total dissolved solids (TDS). This second bank of parameter sensors 178 serves to continuously track the plurality of sensed parameters 108 just enumerated. The temperature sensor, the pH sensor, the resistivity sensor, and the conductivity/TDS sensor are of the same model numbers and are provided by the same manufacturers as previously described. Each of these four sensors is represented as being located in the same enclosure which comprises the second bank of parameter sensors 178. Further, there are four identical banks of these parameter sensors distributed throughout the programmable fluid treatment system 100 for providing a constant stream of data on a real time basis to the programmable computer control subsystem (PCCS) 106 via a (4-20) milliamp communication line 140 to the programmable computer control subsystem (PCCS) 106. In this manner, the programmable computer control subsystem (PCCS) 106 can continuously monitor the mechanical subsystem 104 and track the plurality of sensed parameters 108 during operation.

The fluid medium 102, targeted compounds 144 and engineered chemicals 150 are next directed into a diffused air flotation (DAF) tank 180 through a DAF entry port 182 in the fluid processing line 121 shown in FIG. 3B. In order for the fluid medium 102 to be directed into the entry port 182 of the diffused air flotation (DAF) tank 180, the programmable computer control subsystem (PCCS) 106 ensures that the ball check valve 176 is open and the corresponding drain valve 128 is closed. The ball check valve 176 is positioned in the fluid processing line 121 to prevent back-feeding of the fluid medium 102, targeted compounds 144, and the engineered chemicals 150 caused by siphoning back through the fluid processing line 121 when the second transfer pump 166 is de-energized and shut down. The fluid medium 102, targeted compounds 144, and the engineered chemicals 150 now can flow into the diffused air flotation (DAF) tank 180. The diffused air flotation (DAF) tank 180 is fitted with a set of fluid level sensors or control switches including a low level sensor 184 and a mid-level sensor 186 as shown in FIG. 3B.

When the level of the fluid medium 102, targeted compounds 144, and engineered chemicals 150 is low, the low level control switch 184 is activated and opens the electrical circuit to a controlled diffused air pump 188 which can be a diffuser (air pump/blower/compressor). However, when the level of the fluid medium 102, targeted compounds 144, and engineered chemicals 150 reaches the mid-level of the diffused air flotation (DAF) tank 180, the mid-level control switch 186 activates which energizes the controlled diffused air pump 188. The controlled diffused air pump 188 is utilized for forcibly transmitting air through a tubular pathway 190 to a fine air bubblier block 192 which can be a Ponomaster Model AP 100 kit, No. 3. The diffused air pump 188 and the fine air bubblier block 192 force diffused air into the fluid medium 102. The controlled diffused air pump 188 causes the fine air bubblier block 192 to create fine air bubbles 194 that mix with the fluid medium 102, targeted compounds 144, and the engineered chemicals 150. The engineered chemicals 150 and the fine air bubbles 194 attach to the targeted compounds 144 to be removed from the fluid medium 102. In particular, the fine air bubbles 194 attach to the flocculants and the targeted compounds 144 in the fluid medium 102 which typically is storm water containing contaminants.

This combination in which the engineered chemicals 150 (which includes flocculants) and the fine air bubbles 194 that attach to the targeted compounds 144 in the fluid medium 102 create a floating agglomeration or froth 196 at the surface of the diffused air flotation (DAF) tank 180. The floating agglomeration or froth 196 contains the fine air bubbles 194, the engineered chemicals 150, and the targeted compounds 144. The targeted compounds 144 rise or float to the surface of the fluid medium 102 of the diffused air flotation (DAF) tank 180 with the floating agglomeration or froth 196 where they are removed from the diffused air flotation (DAF) tank 180 by a skimmer (not shown) and directed into a holding tank or drum (not shown) for off-site disposal. The mention of a skimmer includes any suitable mechanical means of removal of the targeted compounds 144. Targeted compounds 144 that are heavier will sink and fall to the bottom of the diffused air flotation (DAF) tank 180 and be removed by other gravity means or a vendor can be employed to vacuum clean the diffused air flotation (DAF) tank 180 after several rain events to prevent clogging of components of the mechanical subsystem 104 with debris.

The diffused air flotation (DAF) tank 180 includes a plurality of separators 198 which enables the cleaner processed fluid medium 102 to be directed to a diffused air flotation (DAF) tank output pathway 199 and on to a specific gravity separator (SGS) tank 200 via gravity as shown in FIG. 3A. The name “cleaner processed fluid medium 102” is intended to indicate that most of the targeted compounds 144, fine air bubbles 194, and engineered chemicals 150 have been removed in the diffused air flotation (DAF) tank 180 and the output is directed to the specific gravity separator (SGS) tank 200 via the diffused air floatation (DAF) tank output pathway 199 and the fluid processing line 121. It is noted that the diffused air flotation (DAF) tank 180 includes two separate drain valves 128 and drain paths 129 with (a) a drain valve 128 and corresponding drain path 129 located between two separators 198, and (b) an additional drain valve 128 and corresponding drain path 129 located underneath the diffused air flotation (DAF) tank output pathway 199. Further, it is noted that the controlled diffused air pump 188, the low level control switch 184, mid-level control switch 186, and each of the pair of drain valves 128 associated with the diffused air flotation (DAF) tank 180 are each connected to the programmable computer control subsystem (PCCS) 106 via a (4-20) milliamp communication line 140 for control purposes as shown in FIG. 3B.

The cleaner processed fluid medium 102 now enters the specific gravity separator

(SGS) tank 200 via gravity flow through the fluid processing line 121 as shown in FIG. 3A. The specific gravity separator (SGS) tank 200 is a multi-chamber settling tank having a tortuous path where the flotation and settling process continues. The tortuous path is created by employing a plurality of partitions 202 which are instrumental in directing the processed fluid medium 102 in such a manner as to cause any residual debris to fall out of the flowing fluid medium 102. The specific gravity separator (SGS) tank 200 also includes a coalescing material 204 through which the processed fluid medium 102 is directed for filtering out fine particles remaining therein. The coalescing material 204 can be fashioned from any suitable material such as polypropylene where the polypropylene material may be employed to fashion the coalescing material 204 in a stacked, wafer-shaped, non-woven material design to cause particles to attach thereto like a filter or a trap. The coalescing material 204 is designed to hold the small particles and debris via the attraction between the small particles and the coalescing material 204. Further, the coalescing material 204 can additionally filter out any oils and other contaminants with an attraction to the coalescing material 204. Those oils and other contaminants will then attach to the coalescing material 204, and float or sink where they are collected resulting in a cleaner processed fluid medium 102. This cleaner processed fluid medium 102 then flows out of the specific gravity separator (SGS) tank 200 on fluid processing line 121 to a discharge surge tank 206. Additionally, the three drain valves 128 and corresponding drain paths 129 positioned beneath the specific gravity separator (SGS) tank 200 in Fig. 3A are shown connected to the programmable computer control subsystem (PCCS) 106 via (4-20) milliamp communication lines 140 for control purposes.

The discharge surge tank 206 includes a pair of level control switches including a low level control switch 208 and a high level control switch 210. The level of processed fluid medium 102 that exists within the discharge surge tank 206 controls the operation of a discharge pump 212 shown in FIG. 3A. The low level control switch 208 when actuated indicates that the level of processed fluid medium 102 is low and thus the discharge pump 212 remains de-energized and not active. However, when the level of the processed fluid medium 102 reaches a high level in the fifty gallon capacity discharge surge tank 206, the high level control switch 210 is actuated. Actuation of the high level control switch 210 energizes the discharge pump 212 which then pumps the processed fluid medium 102 downstream through the fluid processing line 121. It is noted that a single drain valve 128 (typically a gate valve) and a corresponding drain path 129 to a temporary storage facility (not shown) are positioned below the discharge surge tank 206. The single drain valve 128, the low level control switch 208, and the high level control switch 210 are each connected to the programmable computer control subsystem (PCCS) 106 via a (4-20) milliamp communication line 140 for control purposes as shown in FIG. 3A.

The processed fluid medium 102 is then transmitted via gravity flow from the discharge surge tank 206 through the fluid processing line 121 on to a 2″ polyvinylchloride (PVC) True Union through port ball valve 214 prior to passing through the discharge pump 212 shown in FIG. 3A. The ball valve 214 is one of a pair of identical ball valves intended to isolate the discharge pump 212 from the upstream side. The second valve intended to isolate the discharge pump 212 is also a 2″ PVC True Union through port ball valve 216 located just downstream of the discharge pump 212 on FIG. 3A. The discharge pump 212 is a (1-150) gallon/minute (gpm) at 60 psig max, centrifugal pump, 230 volt, 3-phase, 60 Hz, variable drive for high discharge output. As with the first transfer pump 130 and the second transfer pump 166, the discharge pump 212 is shown connected to the programmable computer control subsystem (PCCS) 106 via a (4-20) milliamp communication line 140 for transmitting the sensed parameters 108 to and for receiving the correction signals 110 from the programmable computer control subsystem (PCCS) 106 for pump control purposes. The processed fluid medium 102 exiting the ball valve 216 is then directed to a third flow sensor 218.

As with the previous flow sensing instrumentation, the third flow sensor 218 can be a Signet No. 3-2536-PO having a 2″ installation fitting. The third flow sensor 218 serves to (a) recognize that the processed fluid medium 102 is flowing downstream of the discharge pump 212, and (b) measure the flow rate or speed at which the processed fluid medium 102 is moving through the fluid processing line 121. The third flow sensor 218 is shown connected to the programmable computer control subsystem (PCCS) 106 via a (4-20) milliamp communication line 140 specifically for transmitting the sensed parameters 108 to and receiving correction signals 110 from the programmable computer control subsystem (PCCS) 106 for control purposes. The flow rate of the processed fluid medium 102 represented by the sensed parameters 108 from the third flow sensor 218 is compared with the flow rate of the processed fluid medium 102 as assigned by the programmable computer control subsystem (PCCS) 106. If a difference between the two flow rates exists, then the correction signal 110 (as shown in FIGS. 1 and 2) adjusts the speed of the discharge pump 212 shown in FIG. 3A so that the fluid medium 102 moves through the entire mechanical subsystem 104 at a uniform rate. Since the programmable computer control subsystem (PCCS) 106 relies on the sensed parameters 108 from the third flow sensor 218, then the flow rate measured by the third flow sensor 218 effectively controls the speed of the discharge pump 212. The processed fluid medium 102 is then driven downstream by the discharge pump 212 to a third bank of parameter sensors 220 as shown in FIG. 3A.

The third bank of parameter sensors 220 receives the processed fluid medium 102 flowing in the fluid processing line 121 as shown on FIG. 3A. As with the first bank of parameter sensors 136 and the second bank of parameter sensors 178, the third bank of parameter sensors 220 is utilized for measuring the sensed parameters 108 of the processed fluid medium 102 including temperature, pH, resistivity and conductivity/total dissolved solids (TDS). This third bank of parameter sensors 220 serves to continuously track the plurality of sensed parameters 108 just enumerated. The temperature sensor, the pH sensor, the resistivity sensor, and the conductivity/TDS sensor are of the same model numbers and are provided by the same manufacturers as previously described. Each of these four sensors is represented as being located in the same enclosure which comprises the third bank of parameter sensors 220. Further, there are four identical banks of these parameter sensors distributed throughout the programmable fluid treatment system 100 for providing a constant stream of data on a real time basis to the programmable computer control subsystem (PCCS) 106 via a (4-20) milliamp communication line 140 to the programmable computer control subsystem (PCCS) 106. In this manner, the programmable computer control subsystem (PCCS) 106 can continuously monitor the mechanical subsystem 104 and track the plurality of sensed parameters 108 during operation on a real time basis. Consequently, after evaluation, the programmable computer control subsystem (PCCS) 106 can, if necessary, either increase or decrease the injection level of engineered chemicals 150 required for separating the targeted compounds 144 from the fluid medium 102 in the chemical mix surge tank 142. This is accomplished by controlling the chemical metering pump 146 shown in FIG. 3B.

The processed fluid medium 102 is then driven into a cartridge filter housing 222 shown in FIG. 3A. The cartridge filter housing 222 is a last stage security filter and is of the type which can have a ten micron cartridge filter encased therein (not shown) and a 150 gallon/minute (gpm) through-put capacity. Positioned on each side of the cartridge filter housing 222 is a pair of pressure indicators 224 and 226, respectively. Each of the pressure indicators 224 and 226, also referred to as pressure gauges, has a pressure measurement range of (0-30) pounds/square inch gauge (psig) and can be identified by the product No. GGMEV030-PP. The two pressure indicators 224 and 226 measure the differential pressure drop across the cartridge filter housing 222. When the differential pressure across the cartridge filter housing 222 is equal to or greater than 15 pounds/square inch (psi) as measured by the two pressure indicators 224 and 226, the ten micron cartridge filter (not shown) is deemed fouled and should be changed. Although the two pressure indicators 224 and 226 can be maintained as purely mechanical devices, it may be desirable and is foreseeable that each of the pressure indicators 224 and 226 report their pressure readings as sensed parameters 108 to the programmable computer control subsystem (PCCS) 106. Consequently, each of the pressure indicators 224 and 226 are shown connected to the programmable computer control subsystem (PCCS) 106 via a (4-20) milliamp communication line 140 specifically for transmitting the sensed parameters 108 thereto.

The processed fluid medium 102 flowing within the fluid processing line 121 is then driven to the fourth and final bank of parameter sensors 228 for a final measurement of the sensed parameters 108 as shown on FIG. 3A. As with the three previous banks of parameter sensors 136, 178, and 220, the fourth bank of parameter sensors 228 is utilized for measuring the sensed parameters 108 of the processed fluid medium 102 including temperature, pH, resistivity and conductivity/total dissolved solids (TDS). This fourth and final bank of parameter sensors 228 serves to continuously track the plurality of sensed parameters 108 just enumerated. The temperature sensor, the pH sensor, the resistivity sensor, and the conductivity/TDS sensor are of the same model numbers and are provided by the same manufacturers as previously described. Each of these four sensors is represented as being located in the same enclosure which comprises the fourth bank of parameter sensors 228. Further, parameter sensors 228 is the final of the four identical banks of these parameter sensors distributed throughout the programmable fluid treatment system 100 for providing a constant stream of data on a real time basis to the programmable computer control subsystem (PCCS) 106. This constant stream of data is provided via a (4-20) milliamp communication line 140 to the programmable computer control subsystem (PCCS) 106. In this manner, the programmable computer control subsystem (PCCS) 106 can continuously monitor the mechanical subsystem 104 and track the plurality of sensed parameters 108 during operation on a real time basis. Consequently, after evaluation, the programmable computer control subsystem (PCCS) 106 can, if necessary, either increase or decrease the injection level of engineered chemicals 150 required for separating the targeted compounds 144 from the fluid medium 102 in the chemical mix surge tank 142. This is accomplished by controlling the chemical metering pump 146 shown in FIG. 3B.

Since the fourth and final bank of parameter sensors 228 shown in FIG. 3A is the final monitoring stage that collects real time data, this data is utilized by the programmable computer control subsystem (PCCS) 106 to determine whether the processed fluid medium 102 is clean enough to satisfy the discharge requirements of the Regional Water Quality Control Board. The processed fluid medium 102 is then directed to a discharge valve 230 positioned in the fluid processing line 121. The discharge valve 230 is a 1.5″ three-way polyvinylchloride (PVC) control valve which is connected to the programmable computer control subsystem (PCCS) 106 via a (4-20) milliamp communication line 140. This connection enables the position of the discharge valve 230 to be controlled by the programmable computer control subsystem (PCCS) 106. The discharge valve 230 has two positions including a discharge position 232 and a re-circulation position 234. If the results of the analysis of the sensed parameters 108 by the programmable computer control subsystem (PCCS) 106 is that the condition of the processed fluid medium 102 satisfies the requirements of the Regional Water Quality Control Board, then the processed fluid medium 102 is expelled through the discharge port 232 of the discharge valve 230 to the local municipal storm water drain system. In the present invention, the processed fluid medium 102 is typically processed clean water but could be another fluid medium 102 other than water.

However, if the condition of the processed fluid medium 102 fails to satisfy the requirements of the Regional Water Quality Control Board, then the processed fluid medium 102 is recycled through the re-circulation port 234 of the discharge valve 230 to the influent inlet of the fluid collector 112 and into the fluid collection sump 114 shown in FIG. 3A. Under these conditions, typically referred to as the re-circulation mode, the discharge port 232 of the discharge valve 230 is closed while the re-circulation port 234 is opened. The operator is reminded that other valves in the programmable fluid treatment system 100 may require re-positioning. The fluid medium 102 is then cycled through the programmable fluid treatment system 100 again to test the water quality output thereof to determine whether (1) the mechanical subsystem 104 is failing to function normally caused by faulty equipment, or (2) the entire programmable fluid treatment system 100 has become inundated with storm water caused by excessive rainfall.

The Programmable Fluid Treatment System 100 is controlled by the programmable computer control subsystem (PCCS) 106 that will maintain and control the operating parameters thereof. The operation of the flocculation balance of the medium 102, contact time between the flocculant and the fluid medium 102, and the pH balance are critical and must be monitored and controlled on a full time basis to insure that the effluent make-up satisfies the regulatory requirements. The programmable computer control subsystem (PCCS) 106 is employed in the present invention for controlling and continuously monitoring each stage of the mechanical subsystem 104 for ensuring proper operation thereof. Each major component of the mechanical subsystem 104 is in electronic communication with the programmable computer control subsystem (PCCS) 106. In this manner, the condition of the processed fluid medium 102 will satisfy the regulations of the Regional Water Quality Control Board and the processed fluid medium 102 will be discharged to the local municipal storm water drain system. Referring to FIGS. 1 and 2, the main components of the programmable computer control subsystem (PCCS) 106 are shown. The mechanical subsystem 104 is in electrical signal communication with the programmable computer control subsystem (PCCS) 106 as is clearly shown in FIG. 1. The programmable computer control subsystem (PCCS) 106 is housed within a National Electrical Manufacturers Association (NEMA) rated control panel enclosure 240 which contains the main components thereof. The NEMA rated control panel enclosure 240 is typically a locked enclosure located on-site at the location of the programmable fluid treatment system 100. The entire programmable computer control subsystem (PCCS) 106 is located within the NEMA rated control panel enclosure 240 so that it is conveniently accessible to the system engineer/programmer and the system operator.

The NEMA enclosure 240 houses a User Controllable Open System (UCOS) which includes (1) a plurality of digital/Analog Input/Output Modules 242 commonly referred to as an “input/output board rack” which is physically connected to the mechanical subsystem 104 as shown in FIGS. 2 and 3A-3B. The Digital/ Analog Input/Output Modules 242 are also connected to (2) a Micro-Field Control Unit (FCU) 244 within the NEMA enclosure 240. The Field Control Unit (FCU) 244 is, in turn, also connected back to the Digital/Analog Input/Output Modules 242. The Field Control Unit (FCU) 244 also has reciprocal connections with a (3) Computer Operator Workstation 246 shown within the NEMA enclosure 240 in FIG. 2. The Computer Operator Workstation 246 further has reciprocal connections with an (4) Operator Workstation Touch Screen Control (panel) 248 located within the NEMA enclosure 240. Additionally, an (5) Engineering Workstation (EWS) 250 located exterior to the NEMA enclosure 240 is physically connected to the Computer Operator Workstation 246. A (6) separate antenna 252 mounted on the NEMA enclosure 240 is also directly connected to the Computer Operator Workstation 246. Finally, an (7) Off-Site Access Terminal 254 also includes reciprocal connections with the Computer Operator Workstation 246 as shown in FIGS. 1 and 2.

As shown in FIGS. 1 and 2, the mechanical subsystem 104 is connected to the programmable computer control subsystem (PCCS) 106 via the plurality of communication lines 140. The communication lines 140 shown in FIGS. 1, 2, 3A and 3B carry (a) the plurality of sensed parameters 108 or real time monitoring signals to, and (b) the plurality of correction signals 110 from, the programmable computer control subsystem (PCCS) 106. In FIGS. 3A and 3B, the communications lines 140 are shown carrying these real time signals from various system components to and from the programmable computer control subsystem (PCCS) 106. In FIG. 1, these sensed parameters 108 or real time monitoring signals and the correction signals 110 are shown directed to and from the NEMA rated control panel enclosure 240. However, in FIG. 2, these sensed parameters 108 or real time monitoring signals and the correction signals 110 are directed to the Digital/Analog. Input/Output Modules 242.

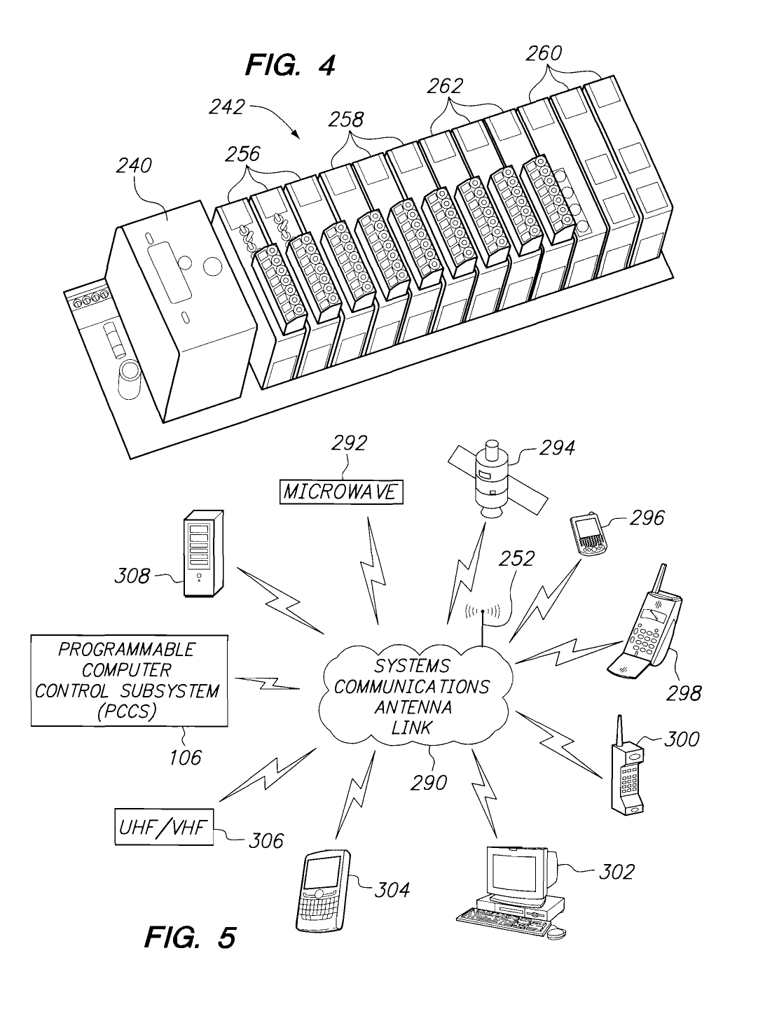

The Digital/Analog, Input/Output Modules 242 are shown in block form in FIG. 2 and as a structural component in FIG. 4. Categories of components located within the NEMA enclosure 240 in addition to the Micro-Field Control Unit (FCU) 244 include {a} a plurality of digital input modules 256, {b} a plurality of digital output modules 258, {c} a plurality of analog input modules 260, and {d} a plurality of analog output modules 262 as shown in FIG. 4. The digital input modules 256 include four isolated channels operating within the range of 2.5 volts-280 volts, AC or DC, while the digital output modules 258 comprise four isolated channels operating within the range of 5 volts-250 volts, AC or DC. Furthermore, the analog output modules 262 include two channels that provide current, voltage or time-proportional outputs, while the analog input modules 260 comprise two isolated or four non-isolated channels that provide current, voltage, ICTD, thermocouple, rate, or RTD inputs. The function of the Digital/Analog, Input/Output Modules 242 (also referred to as the Input/Output Board Rack) shown in FIGS. 2 and 4 is to receive all the sensed parameters 108 (which are digital and analog signals) in real time. All of the digital and analog sensed parameters 108 are then routed to the Field Control Unit (FCU) 244 which is the local micro-Field Control Unit processor unit.

The Field Control Unit (FCU) 244 receives all of the digital and analog sensed parameters (signals) 108 from the Digital/Analog, Input/Output Modules 242 on a line 264. Thus, each of the sensor devices distributed throughout the mechanical subsystem 104 such as the flow sensors 134, 172, and 218 and the multiple banks of parameter sensors 136, 178, 220 and 228, periodically sense, for example, the flow rate, temperature, pH, resistivity, conductivity/total dissolved solids and other parameters of the fluid medium 102. These sensed parameters 108 are transmitted to the Digital/Analog, Input/Output Modules 242 located in the programmable computer control subsystem (PCCS) 106 and are then forwarded to the Field Control Unit (FCU) 244 which is the local micro-processor unit. The Field Control Unit (FCU) 244 then proceeds to identifies the origin of each signal to determine where each sensed parameter (signal) 108 should be transmitted to in the Computer Operator Workstation 246.

Each of the received sensed parameter (signals) 108 is transmitted from the Field Control Unit (FCU) 244 to the Computer Operator Workstation 246 for processing. After suitable processing, the sensed parameters 108 (which are input signals) are transmitted back to the Field Control Unit (FCU) 244 as the correction signals 110 (which are return signals) on a line 266. The Field Control Unit (FCU) 244 then interprets where the correction signals 110 are to be transmitted back to the Digital/Analog, Input/Output Modules 242 for the ultimate return to the correct component location in the mechanical subsystem 104. In other words, the Computer Operator Workstation 246 reads the sensed parameters 108, makes adjustments and control changes and delivers, as necessary, the correction signals 110 back to the appropriate component location in the mechanical subsystem 104 to control the Programmable Fluid Treatment System 100 to meet the requirements of the Regional Water Quality Control Board. Thus, the Digital/Analog, Input/Output Modules 242 serve the input/output function as intended.

The programmable computer control subsystem (PCCS) 106 is a complete control system that includes graphical development software (not shown), a graphical human-machine interface (i.e., Operator Workstation Touch Screen Control 248), and a personal computer (PC) based logic processor (i.e., Field Control Unit FCU 244), and an

Input/Output interface (i.e., Digital/Analog, Input/Output Modules 242). The programmable computer control subsystem (PCCS) 106 is all based on user-configurable, open system standards. Several of the system's distinct, yet tightly coupled components are supported which include: (1) the Engineering Workstation (EWS) 250 utilized for project development; (2) the Computer Operator Workstation (OWS) 246 utilized as an operator interface with the programmable computer control subsystem (PCCS) 106; and (3) the Field Control Unit (FCU) 244 utilized for control logic execution and direct scanning of the Input/Output data stored in the Digital/Analog, Input/Output Modules 242. These components are connected together via the Ethernet or fiber optic, redundant or non-redundant network using various protocols known in the art.

The Engineering Workstation (EWS) 250 shown on FIG. 2 is located external to the NEMA rated control panel enclosure 240 and is the development tool where control schemes are configured and downloaded to the Computer Operator Workstation (OWS) 246 and the Field Control Unit (FCU) 244. The entire project directed to, for example, the Programmable Fluid Treatment System 100, is configured using a single, integrated tool based on graphical Windows standards. Project configuration begins by defining the system architecture including workstations, field control units (FCU's), Input/Output, and networking. The developer simply selects a component for insertion into a graphical representation of the system architecture. Graphical techniques are also used to define the logical relationships among the control elements for multiple devices. The developer “drags and drops” graphical representations of device objects into a device diagram. This device diagram acts as the project's control logic which is substantially downloaded to the Field Control Unit (FCU) 244. The device diagram includes standard devices, such as PID controllers, transmitters, switches, and others. It also includes user-definable devices for pumps, valves, conveyors, etc. The project development tools also support configuration of screen and function security, grouping of command windows, logging, grouping of alarms, generation of project documentation, and more. Entire projects or configuration changes can be downloaded to the Computer Operator Workstation 246 and Field Control Unit (FCU) 244. Changes can be made online.

The Engineering Workstation (EWS) 250 is utilized by the engineering staff/programmers to program, that is, to set the parameters of the programmable computer control subsystem (PCCS) 106 for project development. The Engineering Workstation (EWS) 250 is the only location from which these system parameters can be programmed or modified and only the system engineer/programmer has access thereto. The Engineering Workstation (EWS) 250 is shown in FIG. 1 as connecting to the NEMA enclosure 240 and in FIG. 2 as connecting to the Computer Operator Workstation (OWS) 246 within the NEMA enclosure 240 via a line 268. In particular, the engineering/programming staff utilizes a separate computer at the Engineering Workstation (EWS) 250 to program and download logic code onto a computer located at the Computer Operator Workstation (OWS) 246 located within the NEMA enclosure 240 for changing parameters of the programmable computer control subsystem (PCCS) 106. The changing of parameters typically might occur when field components and/or system hardware are modified or replaced. It is emphasized that only the engineer/programmer working at the Engineering Workstation (EWS) 250 has access to the separate computer located at the Computer Operator Workstation (OWS) 246, not the operator located at the Computer Operator Workstation (OWS) 246.

It is further noted that the Engineering Workstation (EWS) 250 includes the computer that enables the engineer/programmer to program, that is, to set the parameters of the programmable computer control subsystem (PCCS) 106. The computer associated with the Engineering Workstation (EWS) 250 can be a general purpose computer of the desktop or laptop variety which contains suitable computer programs utilized solely to write the programming logic and for selecting the configuration of the programmable computer control subsystem (PCCS) 106. If necessary, the engineer/programmer located at the Engineering Workstation (EWS) 250 can control the operation of the Programmable Fluid Treatment System 100 to meet the objectives programmed into the programmable computer control subsystem (PCCS) 106. Although the Engineering Workstation (EWS) 250 is utilized to set the program logic code, the operator located at the Computer Operator Workstation (OWS) 246 can change certain settings, for example, the speed of a pump which is normally set at the Engineering Workstation (EWS) 250. Access from off-site locations (which can be any location external to the Programmable Fluid Treatment System 100), is available to communicate with the separate computer at the Computer Operator Workstation (OWS) 246 for obtaining the most current readings available of the sensed parameters 108. The Engineering Workstation (EWS) 250 is typically located at a remote station. Off-site locations, including the Engineering Workstation (EWS) 250, communicate with the programmable computer control subsystem 106 by any of a number of communication methods including, but not limited to, radio RF, modem, satellite, telephone lines, Ethernet/Internet, fiber optics, and the like as shown in FIG. 5. The antenna 252 which facilitates this communication is shown in FIGS. 1 and 2 connected directly to the Computer Operator Workstation (OWS) 246 via a line 270.

Reference to FIG. 2 clearly shows that the Computer Operator Workstation (OWS) 246 and the micro-Field Control Unit (FCU) 244 cooperate in the operation of the programmable computer control subsystem 106. The operator of the Programmable Fluid Treatment System 100 utilizes the Computer Operator Workstation (OWS) 246 to monitor and control the process, using the project configuration as established by the Engineering Workstation (EWS) 250. Displays at the Computer Operator Workstation (OWS) 246 include command windows, group displays, and project screens created during project configuration. These displays are populated with the real-time control status of device tags received from the Field Control Unit(s) (FCU) 244. Authorized operators can monitor detailed activity for many types of devices and send commands from displays appearing on the Operator Workstation Touch Screen Control 248. The Computer Operator Workstation (OWS) 246 also allows operators to display/acknowledge current alarms or display historical alarms. Logs and trends can be accessed by menu selection. Authorized operators can change security status or monitor device logic as it is running in the Field Control Unit (FCU) 244. Device diagnostics show the current status for each device tag. Device tags can be toggled on-scan and off-scan, and current values, i.e., sensed parameters 108, can be overridden. The operator interface, e.g., Operator Workstation Touch Screen Control 248, features high-resolution colorgraphics and familiar Windows Graphic User Interface (GUI) interaction. The Windows environment supports display of multiple project screens and windows. Data can be shared with other standard Windows applications.

The Field Control Unit (FCU) 244 executes the control scheme configured on the Engineering Workstation (EWS) 250 and directly scans industry Input/Output (I/O) as provided by the Digital/Analog, Input/Output Modules 242. The Field Control Unit (FCU) 244 provides Input/Output (I/O) services by monitoring and controlling Input/Output (I/O) across standard networks and data highways, such as, for example from the Digital/Analog, Input/Output Modules 242. The Field Control Unit (FCU) 244 can provide simultaneous support for multiple vendors' Input/Output (I/O) and Input/Output (I/O) networks. Field Control Unit (FCU) 244 connections are via standard, plug-in personal computer (PC) cards. This allows incorporation of distributed, distinct Input/Output (I/O) subsystems into common control strategies. Logic processing is performed by the Field Control Unit (FCU) 244 according to the schemes developed on the Engineering Workstation (EWS) 250 during project configuration. The logic for a particular device is solved within one Field Control Unit (FCU) 244 or a redundant pair of Field Control Units (FCU) 244. When a device is inserted into a device diagram during project configuration, it is associated with one Field Control Unit (FCU) 244. In effect, each device is “owned” by a particular Field Control Unit (FCU) 244. That Field Control Unit (FCU) 244 solves the logic for that device, then sends data updates to Computer Operator Workstations (OWS) 246 using exception-based reporting. Device data is shared with other Field Control Units (FCU) 244 if the control scheme requires it.

The flow of data is from the project configuration of the Programmable Fluid Treatment System 100 developed at the Engineering Workstation (EWS) 250 to the Field Control Unit (FCU) 244 and the Computer Operator Workstation (OWS) 246. The project is downloaded to the Field Control Unit (FCU) 244 and then to the Computer Operator Workstation (OWS) 246. The Field Control Unit (FCU) 244 solves the logic internally and sends the data, e.g., correction signals 110, to the Digital/Analog, Input/Output Modules 242 or (I/O) network. Alarms are also part of the device definition and are solved in the

Field Control Unit (FCU) 244 and reported to the Computer Operator Workstation (OWS) 246. The Field Control Unit (FCU) 244 supports all the real-time functionality required of an industrial controller, including, but not limited to: (1) data acquisition; (2) regulatory control; (3) discrete control; (4) sequencing; (5) event-initiated processing; (6) interlocking; and (7) data calculation. The Field Control Unit (FCU) 244 features direct Ethernet network connections and standard interfaces to many specialized intelligent subsystems.

The following information is offered regarding exemplary specifications of the User Controllable Open System (UCOS) micro-Field Control Unit (FCU) 244 shown in FIGS. 2 and 4, the use of which is anticipated in the design and configuration of the programmable computer control subsystem (PCCS) 106. It is anticipated that the processor can comprise a Cirrus CS89712 having the following characteristics: 75 MHz ARM720 CPU core with MMU; 10 Mbps Ethernet; UART; SDRAM controller; Jumper-selectable boot ROM for “fail-safe” boot to download flash; and a JTAG debug port. The memory will be a 16 MB RAM; 8 MB flash memory; and 512 KB battery-backed SRAM. The clock will be a battery-backed realtime clock. The network interface will be an IEEE 802.3 network; 10 Base-T with an RJ-45 connector; The serial port will be an RS-232 with RTS/CTS; using an RJ-45 connector with standard Digi/Connect Tech pinout. The power requirements {not including the Input/Output (I/O) power requirements} are 5.0 VDC (+ or −) 0.1 VDC with typical current loads of {a} 120 mAmps idle; {b} 200 mAmps during flood ping; and {c} 240 mAmps at power-up. The environmental characteristics include (1) an operating temperature range of between (0 degrees-to −60 degrees) Centigrade; (2) a storage temperature range of between (-40 degrees-to −85 degrees) Centigrade; and (3) a non-condensing, humidity range of between (0%-95%).

The following comments will now be offered to further explain the interaction of the Field Control Unit (FCU) 244 and the Computer Operator Workstation (OWS) 246. The micro-Field Control Unit (FCU) 244 is a computer processor unit, the specifications which have been set out above. The function of the Field Control Unit (FCU) 244 is {1} to provide control logic execution as configured by the Engineering Workstation (EWS) 250 and {2} to provide direct scanning of Input/Output (I/O) data where the (I/O) data is the sensed parameters 108 and/or the correction signals 110 being transmitted to or from the Digital/Analog, Input/Output Modules 242 as shown in FIG. 2. The Field Control Unit (FCU) 244 serves as an interface that allows the sensed parameters 108 that have been sensed by the banks of parameter sensors 136, 178, 220, and 228 to read and feed into the computer located in the programmable computer control subsystem (PCCS) 106 within the NEMA enclosure 240. The computer located within the Computer Operator Workstation (OWS) 246 will utilize the sensed parameters 108 to (a) generate reports, and/or (b) adjust parameters such as, for example, alter the concentration of flocculant, concentration of acidic to basic levels for adjusting the pH level of the chemical mix surge tank 142 shown on FIG. 3B. The micro-Field Control Unit (FCU) 244 is installed into a computer at the Computer Operator Workstation (OWS) 246 where the computer can be (1) built into the NEMA enclosure 240, or (2) installed in a laptop computer carried by the systems engineer or the operator.

Furthermore, the Field Control Unit (FCU) 244 is the main processing point of the programmable computer control subsystem (PCCS) 106, that is, it is the location of (1) all input and output communications to and from the programmable computer control subsystem (PCCS) 106 of the measured sensed parameters 108, and also (2) it controls the components of the Programmable Fluid Treatment System 100. It is noted that all signals (e.g., sensed parameters 108 and correction signals 110) pass through the Field Control Unit (FCU) 244 shown in FIG. 2. The Computer Operator Workstation 246 is utilized as an operator interface with the programmable computer control subsystem (PCCS) 106. It is noted that it is not possible to program or set parameters of the programmable computer control subsystem (PCCS) 106 from the Computer Operator Workstation (OWS) 246. In particular, the Computer Operator Workstation (OWS) 246 (1) enables the operator to provide input signals, e.g., sensed parameters 108, and control signals to the programmable computer control subsystem (PCCS) 106, and (2) to monitor and control the process of the Programmable Fluid Treatment System 100 using the project configuration as set by the Engineering Workstation (EWS) 250 as presently defined. It is noted that the Field Control Unit (FCU) 244 and the Computer Operator Workstation (OWS) 246 are physically connected by a pair of data transmission lines. A line 272 transmits data from the Field Control Unit (FCU) 244 to the Computer Operator Workstation (OWS) 246 while a separate line 274 returns processed data, including correction signals 110, from the Computer Operator Workstation (OWS) 246 back to the Field Control Unit (FCU) 244.

The receipt of the sensed parameters 108 from the mechanical subsystem 104 and the return of the correction signals 110 from the programmable computer control subsystem (PCCS) 106 will now be explained in more detail. The sensed parameters 108 are transmitted from the various system components of the mechanical subsystem 104 shown in FIGS. 3A-3B to the Digital/Analog, Input/Output Modules 242 of the programmable computer control subsystem (PCCS) 106 via the communications lines 140. The sensed parameters 108 are measured signals directed to sensors that measure signals such as, for example, temperature, pH, resistivity, and conductivity/total dissolved solids, fluid flow rates, chemical metering, pump speeds, fluid levels, and the like of the mechanical subsystem 104. Some of these measured sensed parameters 108 are digital and some are analog in nature that are fed to the Digital/Analog, Input/Output Modules 242. An exemplary illustration of a suitable hardware combination of the Digital/Analog, Input/Output Modules 242 and the Field Control Unit (FCU) 244 exists in the User Controllable Open System (UCOS) processor shown in FIG. 4. This processor illustrates the Field Control Unit (FCU) 244 mounted on the same chassis as the Digital/Analog, Input/Output Modules 242. The Digital/Analog, input/Output Modules include {a} the plurality of digital input modules 256, {b} the plurality of digital output modules 258, {c} the plurality of analog input modules 260, and {d} the plurality of analog output modules 262 earlier described. The function of the Digital/Analog, Input/Output Modules 242 (also referred to as the Input/Output Board Rack) shown in FIGS. 2 and 4 is to receive all of the sensed parameters 108 (which are digital and analog signals) in real time. All of the digital and analog sensed parameters 108 are then routed to the Field Control Unit (FCU) 244 which is the local micro-Field Control Unit processor unit.

The Field Control Unit (FCU) 244 receives all of the digital and analog sensed parameters (signals) 108 from the Digital/Analog, Input/Output Modules 242 on the line 264 shown in FIG. 2. The Field Control Unit (FCU) 244 continuously monitors the plurality of sensed parameters 108 and is utilized for control logic execution and direct scanning of the sensed parameters 108 (e.g., input/output data of the mechanical subsystem 104) from the Digital/Analog, Input/Output Modules 242 into the computer located at the Computer Operator Workstation (OWS) 246. The Computer Operator Workstation (OWS) 246 is utilized as an operator interface with the programmable computer control subsystem (PCCS) 106. After receipt, the Field Control Unit (FCU) 244 then proceeds to identify the origin of each signal to determine where each sensed parameter (signal) 108 should be transmitted to in the Computer Operator Workstation (OWS) 246 via line 272. All of the data, e.g., sensed parameters 108, that is transmitted to the Computer Operator Workstation (OWS) 246 is continuously interpreted therein. It is noted that a storage memory 276 is located within the Computer Operator Workstation (OWS) 246 as shown in FIG. 2. One of the functions of the storage memory 276 is to store pre-programmed input data 278 therein to assist in controlling the operation of Programmable Fluid Treatment System 100.

The pre-programmed input data 278 is the pre-programmed data stored in the storage memory 276 of the Computer Operator Workstation (OWS) 246 utilized to compare the Input/Output sensed parameters 108 thereto. It is significant to note that the result of the comparison between (1) the sensed parameters 108 transmitted from the various components of the mechanical subsystem 104, and (2) the pre-programmed input data 278 stored in the storage memory 276 of the Computer Operator Workstation (OWS) 246 results in the signal differential or correction signals 110 that are transmitted back to the mechanical subsystem 104 to modify or correct the operation of the Programmable Fluid Treatment System 100. Consequently, the Computer Operator Workstation (OWS) 246 continuously interprets and compares the sensed parameters 108 with the pre-programmed input data 278 stored within the storage memory 276 for generating the plurality of correction signals 110. These correction signals 110 are then transmitted back to the Field Control Unit (FCU) 244 on line 274. The Field Control Unit (FCU) 244 then interprets and subsequently transmits the correction signals 110 to the proper modules (e.g., Digital Input Modules 256, Digital Output Modules 258, Analog Input Modules 260, or Analog Output Modules 262) in the Digital/Analog, Input/Output Modules 242 on line 266. Thereafter, the correction signals are transmitted from the Digital/Analog, Input/Output Modules 242 back to the proper component in the mechanical subsystem 104.

The Field Control Unit (FCU) 244 interprets where the correction signals 110 are returned to in the Digital/Analog, Input/Output Modules 242 after the computer of the Computer Operator Workstation (OWS) 246 reads the sensed parameters 108, makes the adjustments and control changes, and generates the correction signals 110, as necessary, to control the operation of the Programmable Fluid Treatment System 100. The Digital/Analog, Input/Output Modules 242 then sends the corrected, modified and adjusted control changes back to the corresponding parameter locations within the mechanical subsystem 104. This routing forms the “control feedback loop” that transmits the adjusted signals, such that, the Programmable Fluid Treatment System 100 makes modifications to the components of the mechanical subsystem 104. Examples of possible modifications to the components of the mechanical subsystem 104 include, but are not limited to: changes in pump speed of any of the main pumps 130, 166, or 212; volume of flocculant injection into the chemical mix surge tank 142; pH level; or the flow or rate of flow of the fluid medium 102. The computer associated with the Computer Operator Workstation (OWS) 246 continues to constantly interpret the revised modified data, e.g., sensed parameters 108, from the mechanical subsystem 104. This continued monitoring ensures that the adjustments called for by the correction signals 110 are completed properly. In other words, the computer associated with the Computer Operator Workstation (OWS) 246 orders the adjustment or change and the continued monitoring verifies that the changes are actually completed.

These correction signals 110 facilitate adjustment and control modifications to the mechanical subsystem 104 for maintaining the sensed parameters 108 of the fluid medium 102 within the specified limitations set by the Regional Water Quality Control Board. Because of the continuous monitoring of the sensed parameters 108 by the Field Control Unit (FCU) 244 and the continuous interpreting and comparing of the sensed parameters 108 with the pre-programmed input data 278, the required adjustments and control modifications to the components of the mechanical subsystem 104 shown in FIGS. 3A-3B can be verified as having actually been completed. In other words, the computer associated with the Computer Operator Workstation (OWS) 246 reads the data (e.g., sensed parameters 108), initiates adjustment and control modifications, and then implements these adjustment and control changes as necessary to control the Programmable Fluid Treatment System 100. In this manner, each of the regulations that must be met prior to the discharge of the fluid medium 102 in the municipal storm water drainage system are satisfied.

The Operator Workstation Touch Screen Control (Panel) 248 located within the NEMA enclosure 240 is shown in FIG. 2 as being in signal communication with the Computer Operator Workstation (OWS) 246. This connection enables any changes that can be made by the operator at the Computer Operator Workstation (OWS) 246 such as, for example, change in pump speed, to also be made from the Touch Screen Control Panel 248 (and also from the computer located at the Engineering Workstation 250). The signals that pass from the Computer Operator Workstation (OWS) 246 to the Touch Screen Control Panel 248 pass on a line 280. Likewise, the signals that pass from the Touch Screen Control Panel 248 back to the Computer Operator Workstation (OWS) 246 pass on a line 282. The information generated by the computer at the Computer Operator Workstation (OWS) 246 is displayed on the Touch Screen Control Panel 248 over line 280. Conversely, the Touch Screen Control Panel 248 is a transmitter/controller that creates input signals to control, for example, pump speed, are transmitted back to the Computer Operator Workstation (OWS) 246 over line 282. This “reverse connection” from the Touch Screen Control Panel 248 back to the Computer Operator Workstation (OWS) 246 routes the correction signals 110 back to the mechanical subsystem 104 via the Field Control Unit (FCU) 244 and the Digital/Analog, Input/Output Modules 242 as shown in FIG. 2.

As a result, the present invention facilitates the continuous adjusting and correcting of the sensed parameters 108 and reporting on-line and in real time to the regulatory authority. This continuous reporting includes the current operation of the mechanical subsystem 104 including the mix of the engineered chemicals 150 and the condition of the fluid medium 102. This important feature is extremely significant in that the concentration of the targeted compounds 144 during a rain event can be dynamic, that is, constantly changing. Thus the operation of the Programmable Fluid Treatment System 100 can be modified to address this dynamic situation. Under these conditions, the sensed parameters 108 of temperature, pH, resistivity, conductivity/total dissolved solids can be constantly monitored as well as flocculant chemical metering levels, pump speeds, fluid medium flow rates and the like. Thus, the rigid standards set by the Regional Water Quality Control Board can be satisfied prior to the discharge of the processed fluid medium 102 into the local municipal storm water drain system.

The programmable computer control subsystem 106 shows a block exhibiting the Off-Site Access Terminal 254 in FIG. 2. The Off-Site Access Terminal 254 can be any off-site location external to the Programmable Fluid Treatment System 100 that is utilized to communicate with the Computer Operator Workstation (OWS) 246 for obtaining data available from the most current readings available of the sensed parameters 108. The off-site location can be an office computer, even a computer that is located at a local government agency that sets rules and policy. That specific off-site location can seek access to the most recent sensed parameters 108 and receive the data from the Computer Operator Workstation (OWS) 246 on a line 286. Modifications to the operation of the components of the mechanical subsystem 104, such as pump speed or the concentration of the flocculent added to the chemical mix surge tank 142, can be inputted to the programmable computer control subsystem (PCCS) 106 from the Computer Operator Workstation (OWS) 246 via Off-Site Access Terminal 254 on a line 288 shown in FIG. 2. The modifications inputted from Off Site Access Terminal 254 to the programmable computer control subsystem (PCCS) 106 are processed at (1) the Computer Operator Workstation (OWS) 246 to generate correction signals 110, (2) identified by the Field Control Unit (FCU) 244, (3) transmitted to the Digital/Analog, Input/Output Modules 242 on line 266, (4) for eventual return to the corresponding component in the mechanical subsystem 104. Additional modifications can be inputted at Off Site Access Terminal 254 that affect any sensed parameter 108 including the Total Dissolved Solids (TDS), flow and flow rate, output levels at the discharge port 232, fluid levels of various system tanks, contact time of the fluid medium 102 with the flocculant, in addition to temperature, pH levels, resistivity, and conductivity/Total Dissolved Solids (TDS).

The antenna 252 mounted on the NEMA enclosure 240 shown in FIG. 2 provides the programmable computer control subsystem (PCCS) 106 with the capability of communicating with other communication devices over all mediums over a systems communications antenna link 290 as shown in FIG. 5. This communication capability is important because (a) the programmable computer control subsystem (PCCS) 106 can be remotely accessed from Off Site Access Terminal 254 shown in FIG. 2 to verify operations, and (b) the programmable computer control subsystem (PCCS) 106 is verified as controlling the Programmable Fluid Treatment System 100 to meet the discharge specifications as required by the Regional Water Quality Control Board and/or other governing agencies. Several of the communication devices over a plurality of mediums are illustrated in FIG. 5. Some of these communication devices include, but are not limited to: (1) a microwave link 292; (2) a satellite link 294; (3) a radio RF link 296; (4) a cell phone 298; (5) a telephone 300; (6) a Ethernet/Internet link via a desk top or lap top computer 302; (7) a smart phone 304; (8) an Ultra-High Frequency/Very High Frequency (UHF/VHF) device 306; (9) the programmable computer control subsystem (PCCS) 106 shown in FIGS. 2; and (10) a modem/server 308, each illustrated in FIG. 5. Other possible links not shown include a fiber optic link. Many of these links carry low voltage, small signals over telephone lines. It is noted that the antenna 252 shown mounted on the NEMA enclosure 240 is shown directly connected to the Computer Operator Workstation (OWS) 246 via line 270 in FIG. 2. It is further noted that the present invention envisions other communication devices and links for cooperation with the programmable computer control subsystem (PCCS) 106, those communication devices and links not yet developed and available to the public at large.

Through the remote access feature of the Off Site Access Terminal 254 of the programmable computer control subsystem (PCCS) 106 shown in FIG. 2, via the multiple methods of communication set out immediately above and shown in FIG. 5, the operation of the Programmable Fluid Treatment System 100 can be modified to change parameters to meet the conditions of real time operations. These conditions, of course, are required to satisfy the fluid discharge requirements set by the local Regional Water Quality Control Board or other authoritative regulatory agency.

In distinction to the Off Site Access Terminal 254, the NEMA enclosure 240 is located on-site of the Programmable Fluid Treatment System 100 and all control functions are located within the NEMA enclosure 240. The programmable computer control subsystem (PCCS) 106 is designed to interpret the sensed parameters 108 and control signals delivered thereto on the plurality of communication lines 140 from the probes and sensors distributed throughout the mechanical subsystem 104. Some of those sensed parameters 108 include, but are not limited to, temperature, pH level of the fluid medium 102, resistivity, conductivity/total dissolved solids (TDS), flow sensors signals, and the like. The programmable computer control subsystem (PCCS) 106 adjusts the flocculation/separation levels; the pH level of the fluid medium 102 to a neutral reading of (7-8) on a pH scale of (0-14) acidic to basic; system flow levels; and contact time between the fluid medium 102 and the injected flocculants; and system operation to achieve the discharge parameters set by the relevant government agency. The standard of the present invention is always (a) to maximize the quality of the fluid medium 102 discharged into the municipal storm water drain system, and (b) to meet or exceed all federal, state and local requirements and regulations for system operation, data archiving, real time reporting, and discharge requirements.

In the event of a mechanical or electrical problem associated with the operation of the Programmable Fluid Treatment System 100 such as the failure of a pump or a sensor, the programmable computer control subsystem (PCCS) 106 will (a) place the operation of the Programmable Fluid Treatment System 100 in a “safe mode” which typically means a re-circulation mode or shutdown mode, and (b) the programmable computer control subsystem (PCCS) 106 will enter an alarm mode and activate suitable alarms. The re-circulation mode typically refers to positioning re-circulation valve 174 (shown in FIG. 3B) in a suitable position so that the fluid medium 102 follows the re-circulation path 126 through an open isolation ball valve 124 (shown in FIG. 3A) and back into the fluid collection sump 114. The reference to the shutdown mode refers to the de-activation of most major components except those necessary to the discharge of fouled flocculants and targeted compounds 144 harmful to the mechanical subsystem 104. If the sensed parameters 108 of the discharged fluid medium 102 are not consistent with the design specifications, then, for example, the discharge pump 212 is placed in the re-circulation mode (as described herein above) so that impurities resident within the fluid medium 102 are not discharged into the municipal storm water drain system. Additionally, if a pump fails such as, for example, the first transfer pump 130 (shown in FIG. 3A), resulting in a major failure, the programmable computer control subsystem (PCCS) 106 has the capability of alarming and contacting the appropriate repair maintenance group to correct the failure. Simultaneously, the failed pump is cycled into a “safe mode” which typically means that the failed pump is de-energized.

We will now turn our attention to the operation of the Programmable Fluid Treatment System 100 by making reference to the operational flow diagram appearing on FIGS. 6A to 6C. An identification number will be assigned to each step in the process to assist the reader in following the operational flow diagram. In a preferred embodiment, we begin with a first step 320 identified as “START” on FIG. 6A which initiates the operation of the Programmable Fluid Treatment System 100 upon the occurrence of a rain event 322. The initiation of the rain event 322 results in a step 324 which is influent injection level measurement. This step involves influent, e.g., fluid medium 102, filling up the rain fall totalizer 135 (shown in FIG. 3B) which causes the activation of the Programmable Fluid Treatment System 100. The rain fall totalizer 135 collects rain fall to indicate the amount of water falling. An on-off signal is received at the programmable computer control subsystem (PCCS) 106 from the rain fall totalizer 135 in step 326. Thereafter the programmable computer control subsystem (PCCS) 106 initiates an internal diagnostic test in step 328 of all subsystem components which activates all the internal components to begin recording all input signals. The influent, e.g., fluid medium 102, enters the test media mix surge tank or collection sump 114 via the site fluid collector 112 in step 330. Further, a “re-circulate” line carries a signal identified as a separate step 392 (originating on FIG. 6C) which is directed to fluid media 102 which does not satisfy the rigid discharge requirements. This signal in the separate step 392 is directed to the influent entering the collection sump 114 in step 330 shown in FIG. 6A.

The level switches 116 and 118 located in the test media mix tank or fluid collection sump 114 activate all systems in step 332, that is, activates the fluid treatment subsystems, particularly the mechanical subsystem 104, via the programmable computer control subsystem (PCCS) 106. The signals from the level switches 116 and 118 indicate to the programmable computer control subsystem (PCCS) 106 that the fluid media 102 is present and that the subsystem 106 should commence operation. The programmable computer control subsystem (PCCS) 106 then activates all components that move the fluid media 102 in step 334, including all pumps particularly the first transfer pump 130 (and adjusts the pump speed), activates flow monitors 134, chemical metering pump 146, fine air bubblier block 192, and the like. In the next step 336, the flow meter 134 transmits a sensed parameter 108 to the programmable computer control subsystem (PCCS) 106 indicating that fluid media 102 is flowing plus the flow rate of the fluid media 102. The programmable computer control subsystem (PCCS) 106 adjusts the flow rate of the first transfer pump 130 by adjusting the pump speed in step 338. The flow rate is set by the pre-programmed input data 278 shown in FIG. 2, size of the rain event, and the flow switches 116, 118 in the fluid collection sump 114 where (a) the low level switch 118 causes the speed of the first transfer pump 130 to be reduced, while (b) the high level switch 116 causes the speed of the first transfer pump 130 to be increased.

The speed adjustment of the first transfer pump 130 indicated in step 338 is forwarded as a signal back to the step 334 (of activating the first transfer pump 130) by a separate step 340 shown in FIG. 6A. Likewise, the speed adjustment of the first transfer pump 130 in step 338 receives a signal from the adjustments of transfer pump 166 and discharge pump 212 in a separate step 376 shown in FIGS. 6B and 6C. In the next step 342, the signals or sensed parameters 108 from the first bank of parameter sensors 136 are sent to the programmable computer control subsystem (PCCS) 106 for evaluation of the quality of the fluid medium 102 as to targeted compounds 144. In the next step 344, the interpreted sensed parameters 108 are compared with the pre-programmed input data 278 stored in the Computer Operator Workstation (OWS) 246 in the programmable computer control subsystem (PCCS) 106 to provide a first correction signal 110 which is utilized to energize the pumping components associated with the chemical mix surge tank 142. As a result, the programmable computer control subsystem (PCCS) 106 activates the chemical mix equipment associated with the chemical mix surge tank 142 for formulating the engineered chemicals 150 for attacking the targeted compounds 144 in a step 346. In particular, the programmable computer control subsystem (PCCS) 106 ensures that the chemical metering pump 146, the pH chemical metering pump 148, and the flocculant media mixer 152 are energized. Further, the volume of chemical flocculant required to separate the fluid media 102 from the targeted compounds 144 is determined in the step 346. This step 346 clearly indicates that the amount of flocculant is formulated for the specific targeted compounds 144 resident within the fluid medium 102.

The level switches 160, 162, and 164 of the chemical mix surge tank 142 directs the programmable computer control subsystem (PCCS) 106 via the sensed parameters 108 in step 348 to activate the 2^{nd} transfer pump 166 for moving the agglomerated solution comprising the fluid medium 102, engineered chemicals 150 and the targeted compounds 144 through the fluid processing line 121. The second transfer pump 166 moves the agglomerated solution to the second flow sensor 172 which signals the programmable computer control subsystem (PCCS) 106 that the agglomerated solution is flowing and the flow rate thereof in step 350. Thereafter, the programmable computer control subsystem (PCCS) 106 balances the speed of the first transfer pump 130 with the speed of the second transfer pump 166 in step 352 so that the speed of the two pumps is approximately equal. The balancing step 352 shown in FIG. 6B transmits a separate signal in a step 354 (which combines with a separate signal in a step 376 shown in FIGS. 6B and 6C) back to the speed adjustment of the first transfer pump 130 in step 338 (shown on FIG. 6A). Then, in the next step 356, the agglomerated solution flows to the second bank of parameter sensors 178 which transmit up-dated sensed parameters 108 to the programmed computer control subsystem (PCCS) 106 for evaluation of fluid quality. Next, the up-dated sensed parameters 108 derived from the second bank of parameter sensors 178 is compared with the pre-programmed input data 278 (shown in FIG. 2) in the programmable computer control subsystem (PCCS) 106 for providing a second correction signal 110 in step 358.

As a result of this comparison, in step 360 the programmable computer control subsystem (PCCS) 106 adjusts the level of the engineered chemicals 150 (flocculants) for the targeted compounds 144 and the speed of the chemical metering pump 146 and the pH chemical metering pump 148 for controlling the amount of chemicals mixed with the fluid medium 102. This adjustment is based upon the second correction signal 110. Next, the agglomerated solution comprising the fluid medium 102, engineered chemicals 150, and the targeted compounds 144 is directed to the Diffused Air Flotation (DAF) Tank 180 for aeration purposes in step 362. The level switches 184 and 186 of the Diffused Air Flotation (DAF) Tank 180 direct the programmable computer control subsystem (PCCS) 106 to activate the controlled diffused air pump 188 and the fine air bubblier block 192 to generate air bubbles in step 364. The adjustment settings of the fine air bubblier block 192 control the size of the air bubbles directed to the agglomerated solution within the Diffused Air Flotation (DAF) Tank 180. In the next step 366, the air bubbles shown in FIG. 3B attach to the agglomerated solution to carry the agglomerated solution upward forming a rising froth which is removed mechanically in the Diffused Air Flotation (DAF) Tank 180 to an on-site storage container (not shown) by methods known in the art.

The processed fluid medium 102 in the Diffused Air Flotation (DAF) Tank 180 is directed to the Specific Gravity Separator (SGS) Tank 200 which includes the coalescing material 204 in a step 368. The Specific Gravity Separator (SGS) Tank 200 provides a tortuous path for the flow of the processed fluid medium 102. Further, the coalescing material 204 serves as a media to capture any residual compounds or oils or greases that were not captured in the Diffused Air Flotation (DAF) Tank 180. The processed fluid medium 102 is transferred from the Specific Gravity Separator (SGS) Tank 200 to the Discharge Surge Tank 206. In a step 370, the level switches 208 and 210 of the Discharge Surge Tank 206 direct the programmable computer control subsystem (PCCS) 106 to activate the discharge pump 212. The output flow of the discharge pump 212 passes through the third flow sensor 218 as shown in FIG. 3A. The third flow sensor 218 transmits a sensed parameter 108 to the programmable Computer Control subsystem (PCCS) 106 in a step 372 indicating the flow and flow rate of the processed fluid medium 102 by the discharge pump 212. The programmable computer control subsystem (PCCS) 106 then balances the pump speed of the discharge pump 212 with the pump speeds of the first transfer pump 130 and the second transfer pump 166 in a step 374. This pump balancing helps ensure approximate equivalency of the flow of the fluid medium 102 throughout the Programmable Fluid Treatment System 100. A signal in a separate step 376 transmits the pump balancing disclosed in step 374 to the speed adjusting of the first transfer pump 130 in step 338 on FIG. 6A and to the pump speed balancing of the first transfer pump 130 and the second transfer pump 166 in step 352 on FIG. 6B.

Next, the processed fluid medium 102 reaches the third bank of parameter sensors 220 which generate a third set of signals directed to temperature, pH, resistivity and the conductivity/total dissolved solids (TDS) and the like. The signals from the third bank of parameter sensors 220 are transmitted to the programmable computer control subsystem (PCCS) 106 for evaluation of the quality of the processed fluid medium 102 in a step 378. The programmable computer control subsystem (PCCS) 106 determines whether the processed fluid medium 102 satisfies the discharge requirements of the Regional Water Quality Control Board. Thereafter, the signal data derived from the third bank of parameter sensors 220 is compared with the pre-programmed input data 278 in the storage memory 276 of the Computer Operator Workstation (OWS) 246 shown in FIG. 2. This procedure generates a third correction signal 110 as indicated in a step 380. The third correction signal 110 generated by the programmable computer control subsystem (PCCS) 106 then causes the level of the engineered chemicals 150 and flocculants designed for the targeted compounds 144 to be adjusted, if necessary, in a step 382. This third correction signal 110 can require that the level of engineered chemicals and flocculants either be boosted or reduced to provide the processed fluid medium 102 that is consistent with the relevant regulations.

The processed fluid medium 102 is then passed through the cartridge filter housing 222 as shown in FIG. 3A in a step 384 for capturing residual particles that were not intercepted in the active treatment process disclosed in the mechanical subsystem 104. The processed fluid medium 102 then reaches the fourth bank of parameter sensors 228 which generate a fourth set of signals directed to temperature, pH level, resistivity and the conductivity/total dissolved solids (TDS) and the like. The signals from the fourth bank of parameter sensors 228 are transmitted to the programmable computer control subsystem (PCCS) 106 for evaluation of the quality of the processed fluid medium 102 in a step 386. The programmable computer control subsystem (PCCS) 106 determines whether the processed fluid medium 102 satisfies the discharge requirements of the Regional Water

Quality Control Board. Thereafter, the signal data derived from the fourth bank of parameter sensors 228 is compared with the pre-programmed input data 278 in the storage memory 276 of the Computer Operator Workstation (OWS) 246 shown in FIG. 2 in a step 388 to accomplish this goal.

At this stage, the processed fluid medium 102 has been through all the process steps of the active treatment system of the Programmable Fluid Treatment System 100 of the present invention. The processed fluid medium 102 has passed through four banks of parameter sensors and the sensed parameters 108 at each stage have been compared with the pre-programmed input data 278 stored in the Computer Operator Workstation (OWS) 246 shown in FIG. 2. Thus, the next determination in a step 390 is whether the processed fluid medium 102 is sufficiently pure enough to be discharged to the local municipal storm water drain system, or whether the fluid medium 102 must be re-circulated back to the influent inlet associated with the fluid collector 112 for reprocessing. If it is determined by the programmable computer control subsystem (PCCS) 106 that the quality of the processed fluid medium 102 does not satisfy the regulations set by the Regional Water Quality Control Board, the fluid medium is re-circulated back to the influent stage as is shown in a step 392. Step 392 on FIG. 6C is routed back to step 330 on FIG. 6A where the influent enters the test media mix tank or fluid collection sump 114 for reprocessing. However, if the programmable computer control subsystem (PCCS) 106 determines based on the sensed parameters 108 from the fourth bank of parameter sensors 228 that the purity of the fluid medium 102 does meet the requirements of the Regional Water Quality Control Board, then the processed fluid medium 102 is discharged to the municipal storm water drain system as indicated in a step 394. Thereafter, the process is complete indicated by the word “END” in a step 396 on FIG. 6C and is ready to cycle again.

Thus, the preferred embodiment of the present invention is directed to a programmable fluid treatment system 100 including a mechanical subsystem 104 and a programmable computer control subsystem (PCCS) 106 wherein the mechanical subsystem 104 includes a fluid collection sump 114 for capturing, storing, and distributing a fluid medium 102, a chemical mix surge tank 142 for injecting a mix of engineered chemicals 150, into the fluid medium 102 for separating out a plurality of targeted compounds 144 and for controlling the pH level of the fluid medium 102, a diffused air flotation (DAF) tank 180 for creating a floating agglomeration 196 of targeted compounds 144 and engineered chemicals 150 for mechanical removal, the programmable computer control subsystem (PCCS) 106 including a field control unit 244 arranged for continuously monitoring a plurality of sensed parameters 108 from the mechanical subsystem 104, a computer 246 for continuously comparing the sensed parameters 108 with preprogrammed input data 278 stored in the computer 246 for continuously generating correction signals 110 fed back to the mechanical subsystem 104 via the field control unit 244 for maintaining the sensed parameters 108 of the fluid medium 102 within limitations set by a regulatory authority, and for continuously adjusting and reporting in real time to the regulatory authority, the operation of the mechanical subsystem 104 including the engineered chemicals 150 in accordance with a dynamically changing concentration of the targeted compounds 144.

The present invention provides novel advantages over other fluid treatment systems including storm water treatment systems that utilize conventional media filtration known in the prior art. A main advantage of the Programmable Fluid Treatment System And Method 100 (i.e., System 100) for use with processing systems is that: (1) the present invention is an “active treatment system” verses a media filtration system of the prior art; (2) resulting in the components of the System 100 cannot be fouled in the absence of conventional media filtration; (3) and consequently, the System 100 does not have back flush problems associated with clogged media filtration; (4) the System 100 incorporates a fully automated programmable computer control subsystem (PCCS) 106 that includes data logging and transmission of the current status to the system operator/end user and Regional Water Quality Control Board/storm water runoff agency; (5) where the System 100 is constantly reading sensed parameters 108 from components of the mechanical subsystem 104 and comparing the sensed parameters 108 with pre-programmed input data 278 stored in the storage memory 276 shown in FIG. 2; (6) for continuously monitoring the sensed parameters 108 and generating correction signals 110; (7) where the correction signals 110 are utilized to modify the operation of the mechanical subsystem 104 for maintaining the quality of the processed fluid medium 102 within the standards required by the Regional Water Quality Control Board; (8) where all major components of the mechanical subsystem 104 are continuously reporting sensed parameters 108 to the programmable computer control subsystem (PCCS) 106 for evaluation; (9) the System 100 including a Systems Communications Antenna Link 290 that can communication with a plurality of modern communication devices; and (10) the programmable computer control subsystem (PCCS) 106 can be accessed from the Engineering Workstation (EWS) 250, Computer Operator Workstation (OWS) 246, and the Off Site Access (Terminal) 254.

More importantly, (11) the Programmable Fluid Treatment System 100 of the present invention utilizing the active treatment system, meets and exceeds all federal, state and local storm water runoff requirements. Further, (12) the present invention facilitates remote access to the recorded data in the storage memory 276 of the Computer Operator Workstation (OWS) 246 by the Regional Water Quality Control Board or other regulatory agency to verify operations and compliance. This access can be obtained by utilizing any of the communications devices shown in Applicant's FIG. 5. This remote access is an advance in the art in the fact that personnel of the regulatory agency do not have to visit the site to collect the recorded data to verify operations and compliance. The recorded data can be electronically downloaded from an convenient location. Finally, (13) the System 100 exhibits extremely low maintenance upkeep requirements.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility such as, for example, chemical processing plants. It is therefore intended by the appended claims to cover any and all such modifications, applications and embodiments within the scope of the present invention. Accordingly,

What is claimed is:

1. A programmable fluid treatment system comprising:
a mechanical subsystem and a programmable computer control subsystem;
said mechanical subsystem including a fluid collection sump for capturing, storing and distributing a fluid medium;
means for injecting a mix of engineered chemicals into said fluid medium from said collection sump for separating out a plurality of targeted compounds and for controlling the pH level of said fluid medium;
means for creating a floating agglomeration of said targeted compounds and said engineered chemicals, said agglomeration being mechanically removed from said fluid medium; and
said programmable computer control subsystem including a control unit arranged for continuously monitoring a plurality of sensed parameters from said mechanical subsystem, a computer for continuously comparing said sensed parameters with a plurality of pre-programmed input data for continuously generating a plurality of correction signals fed back to said mechanical subsystem via said control unit, said correction signals for maintaining said sensed parameters of said fluid medium within limitations set by a regulatory authority, and for continuously adjusting and reporting in real time to said regulatory authority the operation of said mechanical subsystem including said engineered chemicals in accordance with a dynamically changing concentration of said targeted compounds.

2. The programmable fluid treatment system of claim 1 wherein said fluid collection sump further includes a mixer motor utilized for turning a plurality of impellers to maintain said targeted compounds in solution.

3. The programmable fluid treatment system of claim 1 further including a plurality of pumps employed for moving said fluid medium throughout said mechanical subsystem.

4. The programmable fluid treatment system of claim 1 further including a plurality of flow sensors for transmitting a flow signal to said programmable computer control subsystem for indicating the flow of said fluid medium in said mechanical subsystem.

5. The programmable fluid treatment system of claim 1 wherein said plurality of sensed parameters are transmitted to said programmable computer control subsystem on a real time basis for controlling the operation of said mechanical subsystem.

6. The programmable fluid treatment system of claim 1 wherein said plurality of sensed parameters includes the temperature of said fluid medium measured by a plurality of temperature sensors.

7. The programmable fluid treatment system of claim 1 wherein said plurality of sensed parameters includes the pH level of said fluid medium measured by a plurality of pH sensors.

8. The programmable fluid treatment system of claim 1 wherein said plurality of sensed parameters includes the resistivity of said fluid medium measured by a plurality of resistivity sensors.

9. The programmable fluid treatment system of claim 1 wherein said plurality of sensed parameters includes the conductivity of said fluid medium measured by a plurality of conductivity sensors.

10. The programmable fluid treatment system of claim 1 wherein said fluid medium is comprised of storm water.

11. A programmable fluid treatment system comprising:
a mechanical subsystem and a programmable computer control subsystem;
said mechanical subsystem including a fluid collection sump for capturing, storing and distributing a fluid medium;
a chemical mixing surge tank for injecting a mix of engineered chemicals into said fluid medium from said collection sump for separating out a plurality of targeted compounds and for controlling the pH level of said fluid medium;
a diffused air flotation tank for creating a floating agglomeration of said targeted compounds and said engineered chemicals, said agglomeration being mechanically removed from said fluid medium; and
said programmable computer control subsystem including a control unit arranged for continuously monitoring a plurality of sensed parameters from said mechanical subsystem, a computer for continuously comparing said sensed parameters with a plurality of pre-programmed input data for continuously generating a plurality of correction signals fed back to said mechanical subsystem via said control unit, said correction signals for maintaining said sensed parameters of said fluid medium within limitations set by a regulatory authority, and for continuously adjusting and reporting in real time to said regulatory authority the operation of said mechanical subsystem including said engineered chemicals in accordance with a dynamically changing concentration of said targeted compounds.

12. The programmable fluid treatment system of claim 11 further including a chemical metering pump for injecting said engineered chemicals into said fluid medium within said chemical mixing surge tank to cause said separation of said targeted compounds.

13. The programmable fluid treatment system of claim 11 wherein said diffused air flotation tank further includes a diffused air pump for forcibly distributing air throughout said fluid medium.

14. The programmable fluid treatment system of claim 11 wherein said diffused air floatation tank further includes a fine air bubblier for creating fine bubbles for mixing with said fluid medium, said targeted compounds, and said engineered chemicals for forming said floating agglomeration.

15. The programmable fluid treatment system of claim 11 further including a multi-chamber settling tank having a coalescing material for attracting particles suspended in said fluid medium.

16. The programmable fluid treatment system of claim 15 wherein said coalescing material is comprised of polypropylene.

17. The programmable fluid treatment system of claim 11 wherein said fluid medium is comprised of storm water.

18. A method for treating a fluid medium utilizing a programmable computer controller, said method comprising the steps of:
capturing, storing and distributing a fluid medium that flows within a mechanical subsystem;
injecting a mix of engineered chemicals into said fluid medium for separating out a plurality of targeted compounds and for controlling the pH level of said fluid medium;
creating a floating agglomeration of said targeted compounds and said engineered chemicals for enabling the mechanical removal of said floating agglomeration;
continuously monitoring a plurality of sensed parameters from said mechanical subsystem utilizing a control unit of a programmable computer controller;
continuously comparing said sensed parameters with a plurality of pre-programmed input data stored in a computer;
continuously generating a plurality of correction signals within said computer for feeding back to said mechanical subsystem for maintaining said sensed parameters of said fluid medium within limitations set by a regulatory agency; and
continuously adjusting and reporting in real time to said regulatory authority the operation of said mechanical subsystem including said engineered chemicals in accordance with a dynamically changing concentration of said targeted compounds.
